(19) United States
(12) Patent Application Publication
(10) Pub. No.: US 2010/0120011 A1
(43) Pub. Date: May 13, 2010

(54) TECHNOLOGY PLATFORM AND METHODS FOR FACILITATING, CULTIVATING AND MONITORING MENTORING RELATIONSHIPS

(75) Inventor: Mike O'BRIEN, Brooklyn, NY (US)

Correspondence Address: MORRISON & FOERSTER LLP, 1650 TYSONS BOULEVARD, SUITE 400, MCLEAN, VA, 22102, US

(73) Assignee: iMentor Interactive, New York, NY (US)

(21) Appl. No.: 12/615,767

(22) Filed: Nov. 10, 2009

Related U.S. Application Data
(60) Provisional application No. 61/113,110, filed on Nov. 10, 2008.

(51) Int. Cl. G09B 7/00

(52) U.S. Cl. 434/362

(57) ABSTRACT

Mentors and mentees may be matched with each other through computational matching processes. Interactions between the mentors and mentees may be structured and assisted through computational tools and interfaces.

### CROSS-REFERENCE TO RELATED APPLICATIONS

This application claims priority to U.S. Provisional Application No. 61/113,110, filed on Nov. 10, 2008, the disclosure of which is hereby incorporated by reference in its entirety.

### BACKGROUND

1. Field of the Invention

The invention relates generally to technologies and techniques for facilitating, cultivating and monitoring mentoring relationships, such as those between aspiring youth and knowledgeable adults. More specifically, selected embodiments relate to technology platforms and related methods for performing tasks such as matching mentors with compatible mentees, facilitating interactions between mentors and mentees, monitoring ongoing relationships between mentors and mentees, and providing resources for ongoing mentoring relationships.

2. Description of Related Art

Positive mentoring relationships can help youth and others to find direction, skills, encouragement, and resources they need to be successful in their careers and in life. As an example, a college graduate, acting as a mentor, may help a high school student to prepare for college admission and to choose a compatible field of study. Similarly, a working professional, acting as a mentor, may help a young adult to chart a course toward success in a particular profession.

Many groups, such as churches, civic organizations, and even corporations, have created mentoring programs to help connect mentors with compatible mentees. A typical program will match mentors with mentees based on a variety of compatibility factors, such as work and personal background, in combination with a variety of convenience factors, such as the mentor's availability and location. The mentors and mentees will then establish regular meeting times for discussing goals, plans, and other issues related to the mentees' development.

Unfortunately, many groups have found that potential mentors are discouraged from participating in mentoring programs due to the convenience factors. For instance, working professionals are commonly unable to meet with mentees on a regular basis because of sporadic work commitments, limited discretionary time, and commuting overhead. In addition, some groups have also found that potential mentors are discouraged from participating due to the difficulty of preparing for visits with mentees. In other words, the burden of planning and structuring visits based on the individual needs of mentees presents another obstacle to mentors' participation in mentoring programs.

### SUMMARY

Recognizing at least the above difficulties faced by current mentoring programs, the inventors have developed technology solutions to make mentoring more attractive to potential mentors, and to ease the burden of conducting ongoing mentoring activities. These solutions include systems allowing individuals to perform mentoring activities through a combination of in-person and virtual interactions. The systems can also provide structure for the interactions by suggesting topics of communication, facilitating event scheduling, and providing a variety of other mentoring tools.

### BRIEF DESCRIPTION OF THE DRAWINGS

FIG. 1 shows a simplified system configuration for a mentoring technology platform.

FIG. 2 illustrates an example of a mentoring host system within the mentoring technology platform of FIG. 1.

FIGS. 3 and 4 illustrate status indicators for users of the system in FIG. 1.

FIGS. 5A-5C illustrate various navigation hierarchies that may be provided within a user program to allow different types of users to access available software functions or tools.

FIG. 6A shows examples of messages that may be presented to different users of the system shown in FIG. 1.

FIG. 6B shows a chart indicating how some users may determine which features are available to other users.

FIG. 7 shows a table indicating properties that can be assigned to a partner site within the system of FIG. 1.

FIG. 8 illustrates a simplified method for enrolling mentor and mentee users in a mentoring program using a system such as that illustrated in FIGS. 1 and 2.

FIGS. 9A-9B illustrate a user management interface.

FIGS. 10A-10I and 11A-11C illustrate a mentor profile that may be viewed via the system of FIG. 1.

FIG. 12 illustrates multiple profiles associated with a single user.

FIG. 13 illustrates a login screen for a user having multiple profiles.

FIGS. 14A-14C illustrate example methods for matching mentors with mentees.

FIG. 15 illustrates a comparison between different user profiles.

FIG. 16 illustrates an interface for creating matches between mentors and mentees.

FIG. 17 shows a table of values that may define groups of users and indicate interactions that can be performed by members of the groups.

FIG. 18 illustrates a new e-mail notification, which may be sent to e-mail recipients and provide access to an e-mail message.

FIGS. 19A-19B illustrate a graphical user interface for composing e-mail messages within the system of FIG. 1.

FIGS. 20A-20C illustrate various tools that may provide structure for a mentoring relationship and may assist mentors and mentees in their communications with each other.

FIGS. 21A-1, 21A-2, 21B-1 and 21B-2 illustrate example techniques for managing e-mail messages within the system of FIG. 1.

FIGS. 22 and 23A-23B illustrate features and tools that may be used to manage a mentoring curriculum for mentors and mentees.

FIG. 24 illustrates one example of an interface that can be used to create a session.

FIGS. 25 and 26 illustrate monitoring and tracking tools.

FIGS. 27 and 28 illustrate tools for partner site analysis.

FIGS. 29A, 29B-1 and 29B-2 illustrate tools for conducting session analyses.

FIGS. 30A-30I illustrate an interface for tracking the activities of an individual mentor.

FIGS. 31 and 32 show information fields that may be used to create and monitor events.

FIG. 33 illustrates information that may be included in personal appointments.

FIGS. 34A-34B illustrate an interface through which user reports may be accessed.

FIG. 35 illustrates an example of a computing device.

### DESCRIPTION OF EMBODIMENTS

Selected embodiments of the invention are described below with reference to corresponding drawings. These embodiments are provided as teaching examples and should not be construed to limit the scope of the invention as defined by the claims.

In general, the disclosed embodiments provide technology platforms and methods that can be used to facilitate, cultivate, and monitor mentoring relationships. Some of the embodiments may be implemented, for instance, within a system comprising a network of computing devices, client/host software applications, database hardware/software, web interfaces, and so on.

The disclosed embodiments may be employed by any type of organization or individual, but they may be particularly useful for non-profit organizations conducting mentoring programs. As an example, a software package providing one or more of the disclosed mentoring tools and resources may be provided to a non-profit organization to support a mentoring program.

The basic operation of at least one embodiment involves initial steps for establishing mentoring relationships, and subsequent steps for carrying out the mentoring relationships. For instance, in one embodiment, a prospective mentor begins by filling in a mentor application through a secure web page. The application may require the mentor to enter personal information, such as qualifications to be a mentor, personal interests and background, as well as logistical information, such as availability, work schedule, location, and so on. Once the information is entered, the applicant may be screened either by an automated process or by a human reviewer to determine the applicant's fitness to be a mentor.

Assuming that the applicant is deemed qualified for mentoring, a web host program (e.g., a software engine running on a host server) may then use the applicant's information to automatically identify potential matches from a collection of potential mentees stored in a database. In order to create a desired level of compatibility between mentors and mentees, the host program may use an automated matching algorithm that compares numerous parameters of the prospective mentors against the database of mentees. Example parameters may include specific characteristics that mentees have requested, the prospective mentor's education, work experience, and location.

Using these parameters, the host program may scan the database of mentees in search of a match for a prospective mentor. During the scanning operation, the host program may rate potential matches with a “strength of match” score, which may be generated, for instance, by various compatibility measures between mentors and mentees, such as similarity of interests, geographical proximity, and so on. After the scanning operation is complete, the host program may then display a list of candidate matches with the highest strength of match scores, allowing a human user to choose a match from among the candidates. Alternatively, the program may simply assign the mentor to a particular “best fit” mentee. As an alternative to scanning a prospective mentor against a group of mentees, the program could also scan a mentee against a group of potential mentors, in which case, the host program could display potential mentor matches, and perform other steps similar to those discussed above.

Once a mentoring match is established, mentoring activities may be carried out using a combination of virtual and in-person interactions between the mentor and mentee. The virtual interactions may include, for instance, e-mail conversations, chat sessions, and other electronic communications. In-person interactions typically involve face-to-face meetings for conversation or other constructive or casual activities.

The host program may assist the mentor in carrying out the mentoring activities in a variety of ways. For instance, the program may provide a structural framework for e-mail conversations by suggesting discussion topics for the mentor to raise with the mentee. These suggestions may be provided to the mentor, for instance, by displaying writing prompts—i.e., indications of what to write—to the mentor within an e-mail interface. The suggested topics may be aimed, for instance, at helping the mentor and mentee to establish a relationship of trust, developing a common understanding of the mentee's goals, needs, and challenges, and helping the mentor to move the mentoring relationship through progressive stages, such as the landmark stages a student mentee must pass in order to reach college. The program may also provide a calendar of events that can be accessed by both the mentor and the mentee to coordinate meetings, to keep track of goals, and store other relevant information.

The host program may also include tools for monitoring the mentoring relationships and evaluating relevant activities of mentors and mentees. Such tools may include, for instance, software modules that track the frequency of e-mail communications and in-person meetings, compare mentoring activities against benchmarks, and determine whether the mentees' goals are being met. The monitoring tools may also include surveys designed to elicit comments and suggestions from mentors and mentees on topics such as the status of the mentoring relationship and how to improve it.

The online mentoring activities such as e-mail, chat, calendars, and so on, are typically performed within a secured online environment. Such an environment is preferably closed except to the mentors and mentees and those with administrative privileges to monitor mentoring activities. Example techniques for securing information within the mentoring system include encryption of transmissions made through the internet or other networks, encryption of stored information, maintenance of servers within a secure location, and so on.

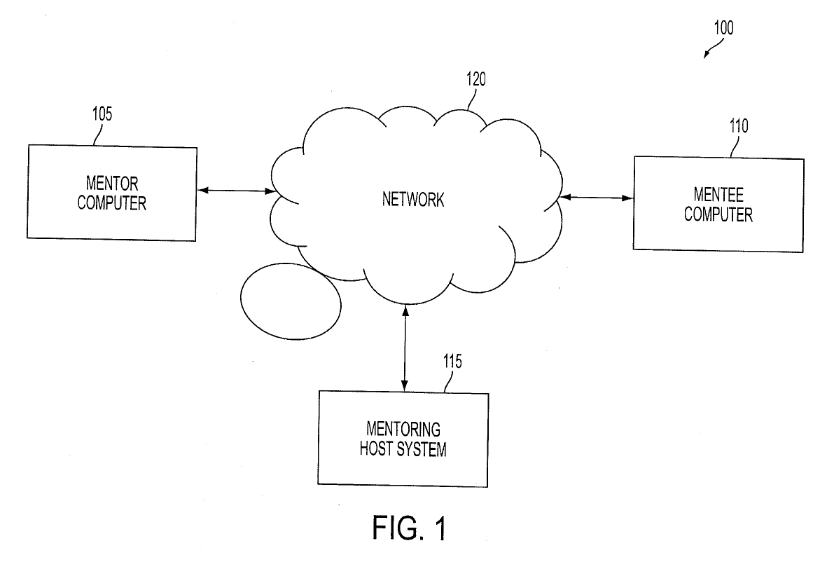

FIG. 1 shows a simplified system architecture that can be used to carry out mentoring activities such as those described above. As illustrated in FIG. 1, a system 100 comprises a mentor computer 105, a mentee computer 110, and a mentoring host system 115 connected to each other via a network 120 such as the internet. Although FIG. 1 shows a limited number of users and physical machines, the system could be scaled up to use any number of interconnected machines and users.

During typical operation, a mentor accesses the mentoring host system 115 via the mentor computer 105, and a mentee accesses the mentoring host system 115 via the mentee computer 110. The mentoring host system 115 provides services such as e-mail and calendar hosting, and data storage, to name but a few. Additionally, mentoring host system 115 may include software for performing a number of mentoring-specific tasks, such as assisting mentors in performing mentoring functions, receiving mentor applications, performing matches between mentors and mentees, monitoring mentoring activities, and so on.

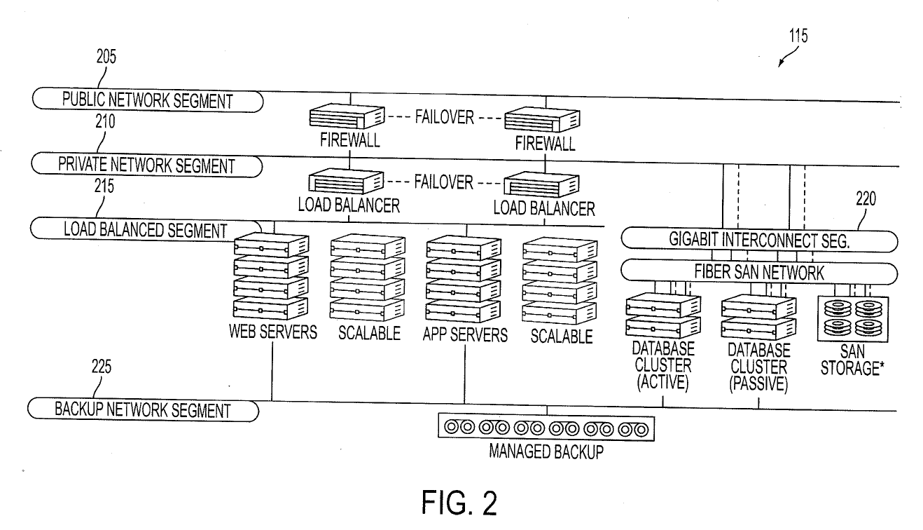

FIG. 2 shows a detailed example of one type of physical architecture for mentoring host system 115. In the example of FIG. 2, mentoring host system 115 comprises a public network segment 205 separated from a private network segment 210 by a firewall. The private network segment 210 includes load balancing hardware and software for allocating computational tasks to the resources within a load balanced segment 215. It also includes an interface to a database segment 220 capable of performing database queries. The load balanced segment 215 includes web and application servers capable of executing software for mentoring activities. A backup segment 225 stores redundant copies of information maintained in segments 215 and 220.

Users, such as mentors, mentees, and administrators, may access the resources in system 100 via an interface such as an internet browser or a client software application. To protect user privacy, access to the resources may be restricted according to user types. For instance, mentors and mentees may be granted access to information pertaining to their mentoring relationship, but not to the mentoring of others. Meanwhile, administrative users may have access to data pertaining to a number of mentoring relationships to allow them to monitor those relationships.

A number of different types of users may use system 100. For instance, system 100 may have one or more “super administrators” (SA) with access to most of the data in system 100. An SA may set up, monitor and maintain the accounts for the other users of system 100. System 100 may also have one or more “members,” which are organizations or entities that sign up to use system 100. For instance, a non-profit entity may sign up as a member to run a mentoring service using system 100. Each member may have a number of constituent users, including member administrators (MA), site coordinators/teachers, mentors, mentees, alumni, parents, and so on. Among those constituent users, those without administrator rights may be termed “front-end users” and those with administrator rights may be termed “back-end users.”

The member administrator for an organization may have access to the user data for that organization and may provide service for the members, such as maintenance, setup, and monitoring. Site-coordinators/teachers may have administrative rights to access data pertaining to corresponding sub-sets of the users. Those sub-sets of users may be referred to as “partner sites,” and each member may have any number of partner sites.

SA users may also create new member sites, and they may edit and view content and communications of members and partner sites. New SA users can only be created by other SA users. Yet another type of user—national administrator (NA)—is similar to a SA user but may access member groups based on geographical scope. As an example, an NA user for the Boys & Girls Club may have access to all of the corresponding users nationwide, while regional members are managed by administrators at a more local level. New NA users can be created by SA users or other NA users.

Member administrators (MA) may have full access to manage member sites, partner sites, and mentor and mentee data. New MA users can be created by SA, NA or other MA users. Partner administrators (PA) may view and manage users within a partner group—i.e., mentors and mentees. New PA users can be created by SA, NA or MA users. PA are always assigned to at least one partner site but can also be assigned to multiple partner sites. Each mentor typically has access to contacts in their address book only as well as to the front-end tools assigned by the member to which they belong (i.e., calendar, blogs, resource database, public profiles, etc.). Similarly, mentees have access to contacts in their address book and to the front-end tools assigned by the member to which they belong (i.e. calendar, blogs, resource database, public profiles, etc.).

System 100 may include a filtering function for retrieving information for the different users. For instance, a SA user may wish to view information for one of the member users. The filtering function may be invoked, for instance, through a graphical user interface (GUI) having boxes that can be checked to indicate the scope of information desired by the requesting user. By highlighting the boxes and activating a search button or its equivalent, the user may cause the filtering function to, e.g., generate a custom database query to retrieve desired information.

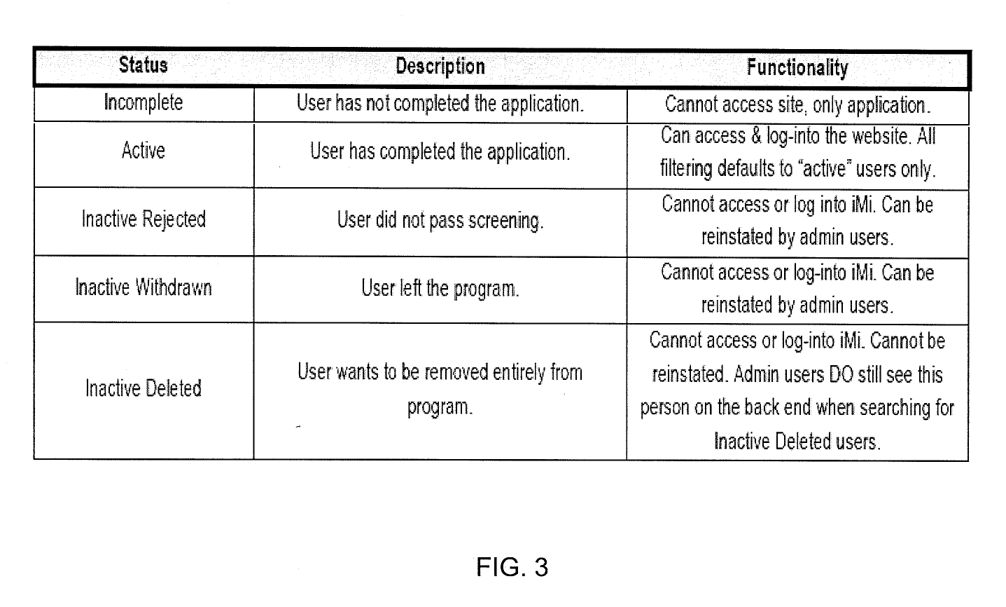

The front-end users typically gain access to system 100 by passing through an application, or screening process. As they pass through the process, their status may be recorded by system 100 as indicated in FIG. 3. In the example of FIG. 3 and other portions of this disclosure, the moniker “iMi” may denote system 100 or another technology platform configured to perform mentoring functions.

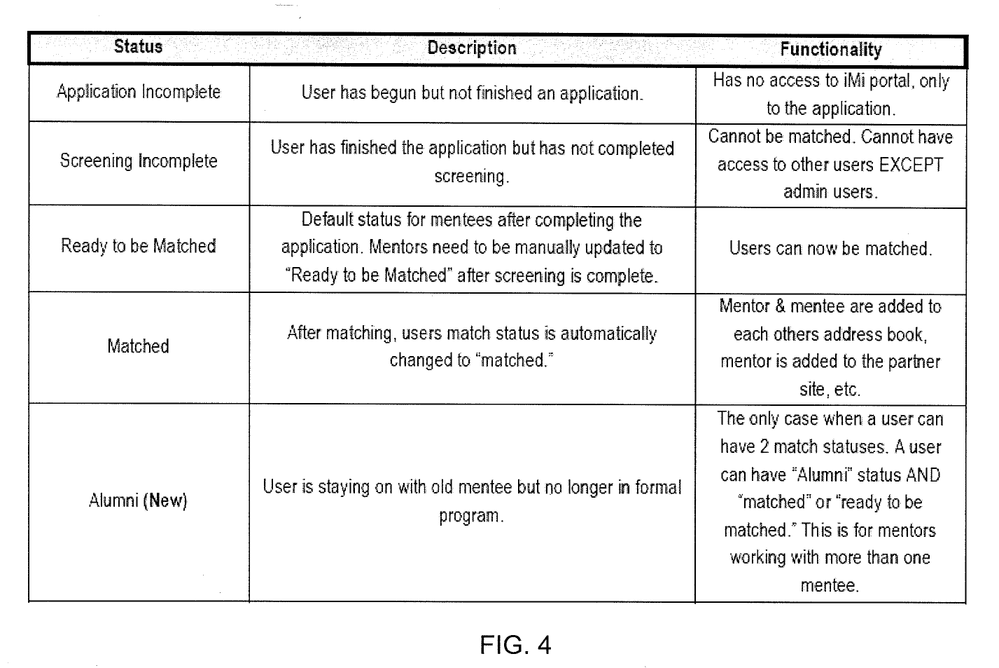

Front-end users, such as mentors and mentees, may also have a “match status” indicating whether they have been matched in a mentoring relationship. For instance, a mentor has the status “matched” when the mentor is paired with a mentee. FIG. 4 illustrates different status indicators for mentors and mentees. As indicated by FIG. 4, the match status also determines some of the user's permissions.

The program or interface provided to users (denoted “user program” for convenience), may be customized by a corresponding member organization or entity. Such customizations (or “program preferences”) may be adopted as defaults for mentors and mentees, they may be assigned to one or more partner sites, they may influence default searches used to match mentors and mentees, and they may appear as a standard filter for all applicable pages.

Additionally, mentors may be assigned program preferences based on the choices they make in their online application. They can select as many preferences as desired, including no preference. Partner sites may be assigned program preferences when an administrator creates or edits a partner site. Mentor preferences may also be used to match mentors with particular partner sites having compatible partner site preferences.

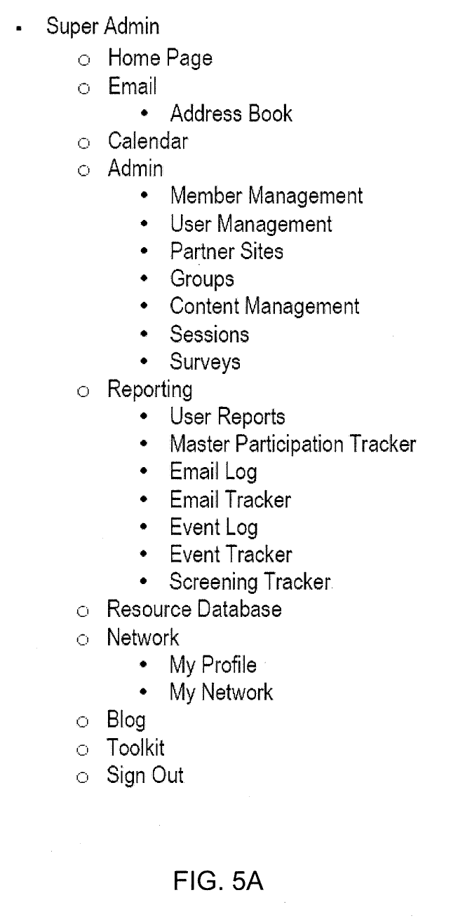

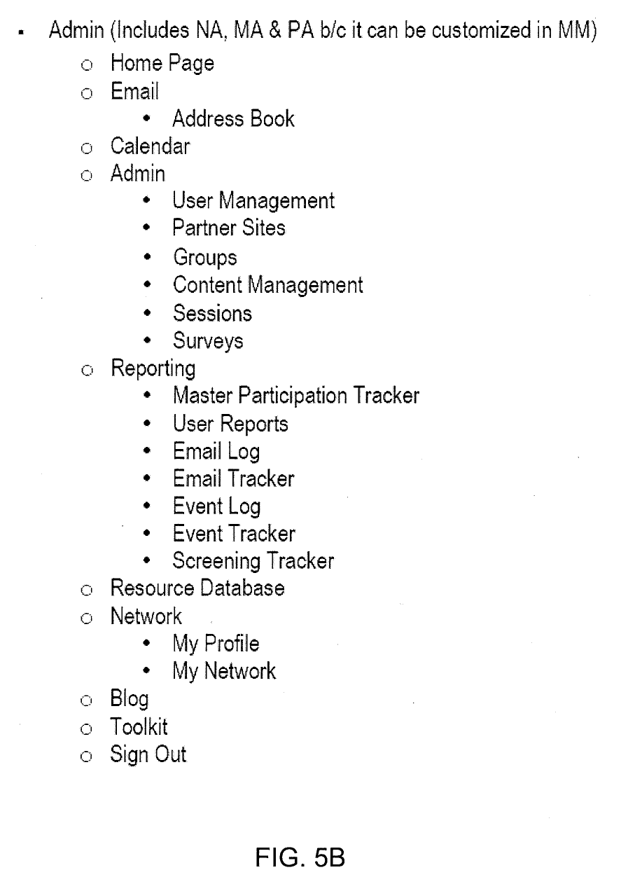

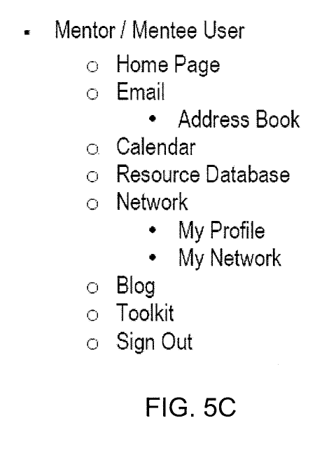

FIGS. 5A-5C illustrate various navigation hierarchies that may be provided within the user program to allow different types of users to access available software functions or tools. More specifically, FIG. 5A illustrates a hierarchy for a SA user, FIG. 5B illustrates a hierarchy for an administrative user, and FIG. 5C illustrates a hierarchy for a front-end user. In addition to the unique navigation hierarchy, a distinct login page may be provided to different users, different members, and so on.

As an example of how to use of a navigation hierarchy, a SA user may click on a series of graphical elements within the hierarchy to create a member site. This series of elements may include, for instance, the following: (1) a button labeled “User & Groups” at a first level of the hierarchy, (2) a button labeled “Member Management” at a second level of the hierarchy, and (3) a button labeled “Add” at a third level of the hierarchy. Once these buttons have been activated, a set of fields may be displayed. Data defining the member site may then be submitted by populating the fields. Such fields may include, for instance, the following:

a. General Information
i. Name
ii. Status—Active/Inactive
iii. Contract Start Date
iv. Contract End Date
v. # of Partner Sites
vi. URL Name (The display name when displaying Member URL)
vii. Primary Contact
viii. Time Zone (Member sites may be time zone specific, an example of why this is required is delivery of timely messages to Mentors & Mentees when an event or communication is due)
ix. Country
x. Street address
xi. City
xii. State
xiii. Zip Code
xiv. Phone
xv. Fax
xvi. Website
xvii. About
   1. Choose Program
      a. Complete Required fields
   2. Choose available features
      a. E-mail
      b. Calendar
      c. Mentee Profile
      d. Users & Groups
      e. Partner Sites
      f. Content Management
      g. Reporting
      h. Admin
      i. Mentor Profile
   3. Assign prompts
      a. Check Prompts to include
      b. Reorder by clicking up and down arrows

b. Platform customization
i. Geographic Area
ii. Member Section
iii. Member Section Plural
iv. Embed URL
v. Teacher Abbreviation
vi. Youth/Mentee Abbreviation
vii. Volunteer/Mentor Abbreviation
viii. Same Gender Match Y/N
ix. Editor Language—English/Vietnamese
x. All required e-mail messages (These should be pre-filled based on default copy)

Once a member site has been created, the member site may subsequently be managed or edited by an SA user who first searches for the member site via a graphical interface, and then, once the site is located, edits or examines the above fields. SA users or other administrators may also manage members by constructing surveys for mentors and mentees to complete at the time of registration. The answers may then be used as part of the criteria for matching mentors and mentees.

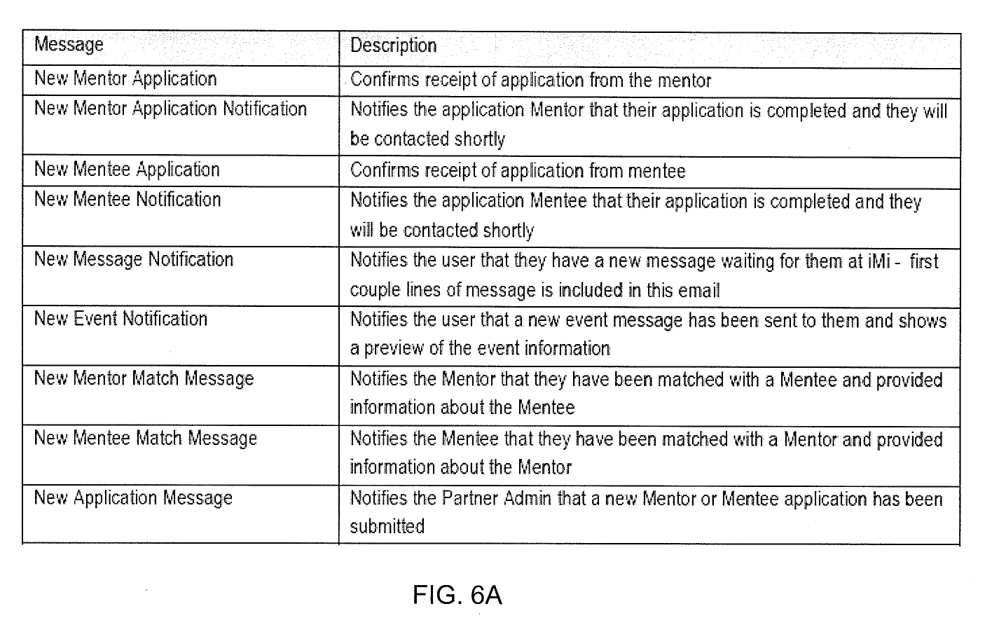

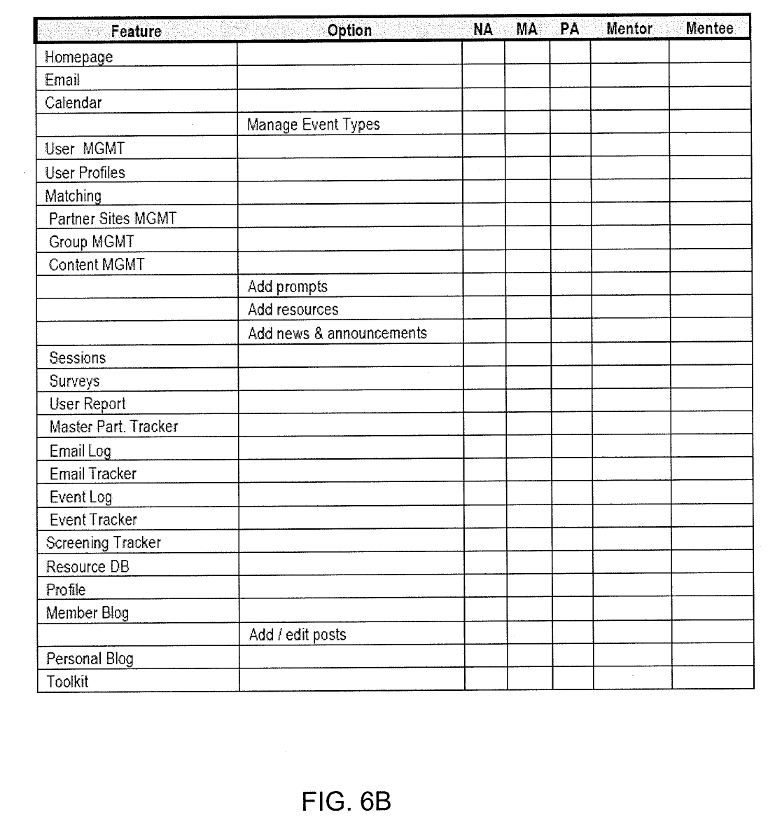

FIG. 6A shows examples of messages that may be presented to different users. Such messages may be presented in any of several different forms, such as pop-ups, e-mails, and so on. In some embodiments, the messages may be accessed through the above navigation hierarchy.

FIG. 6B shows a chart indicating how some users may determine which features are available to other users. As an example, a SA user may choose to provide mentors with default access to e-mail, while providing administrative users with default e-mail management capability over mentors.

As an additional aspect of member management, established member sites may be provided with a variety of customizations. For instance, in one customization, particular screening procedures can be established for mentor applications. In one example of such a screening procedure, a user may elect to collect the following information from the potential mentor: social security number, driver's license information, criminal background, employment termination, supervisor or employment verification, references, etc.

Member management may further involve tools or features whereby single or multiple SA users may be assigned to oversee a particular member's activities, or a number of users may be automatically tracked and automated messaging may be provided to the assigned SA at designated capacity levels (e.g., 80% or 100%).

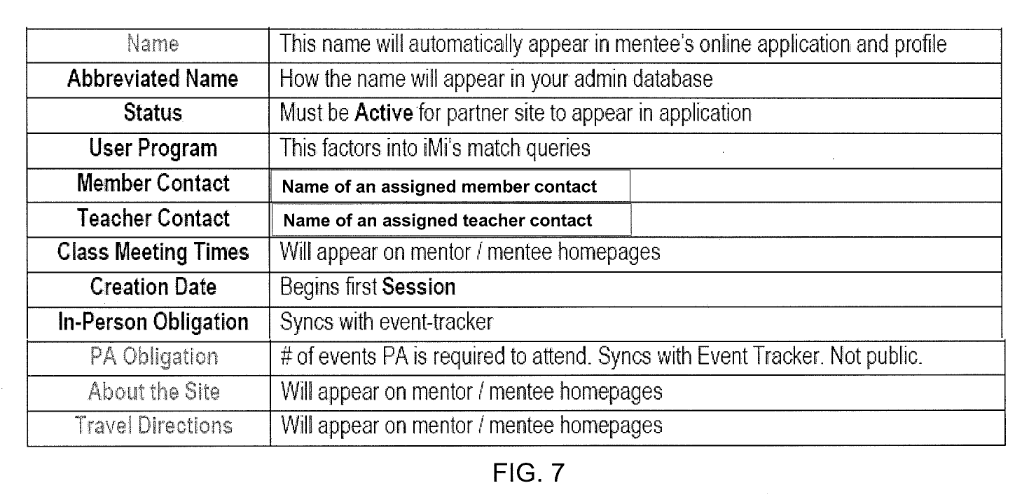

FIG. 7 shows a table indicating various properties that can be assigned to a partner site. When a partner site (PS) is created, a partner site profile is also dynamically created. A partner site profile provides a quick glance at the users included in the PS. The PS may include, for instance, the following information: a super administrator, member administrator, national administrator, information about the partner (e.g., name, location, etc.), information on communications within the partner network (e.g., blogs, e-mails, scheduled events), and information on the partner network.

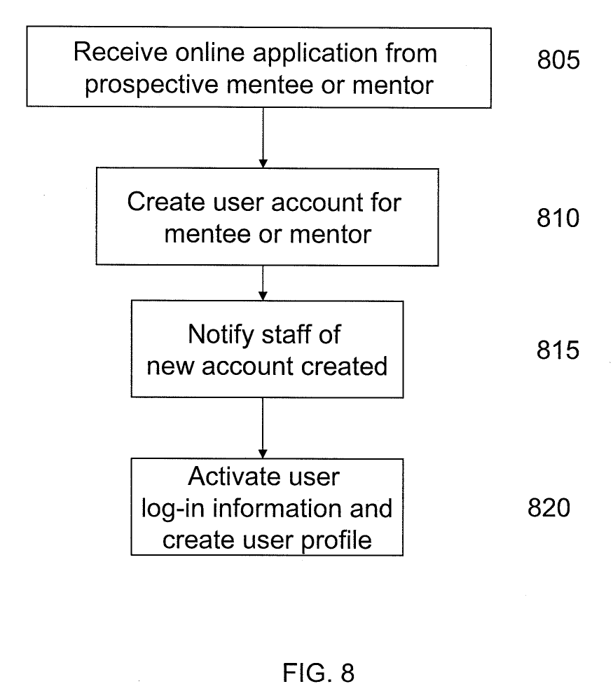

FIG. 8 illustrates a simplified method for enrolling mentor and mentee users in a mentoring program using a system such as that illustrated in FIGS. 1 and 2. In the description that follows, example method steps are denoted by parentheses (xxx).

In the method of FIG. 8, the system receives an online application from a mentor or a mentee (805). The system then automatically creates a user account (810). Thereafter, the system provides notification of the application to a staff member, such as a SA user, a MA user, or a PA user (815). Then, the staff member activates user login information for the user, such as a username and password, and creates a user profile (820). As part of this process, a user e-mail account may be created, and the new user's information may be added to a user management portal or a user report generation module.

After the application is submitted in step 805, a mentor match status is typically set to “screening incomplete.” The status may change after the a mentor is screened based on a set of screening and/or training requirements. Mentor screenings may include, for instance, a series of phone or e-mail interviews. System 100 may provide tools to which allow users to efficiently manage the mentor screening process.

A typical mentor screening process may be divided into three major steps as follows: (1) identifying users who are “screening incomplete”; (2) conduct screening conversations, interviews, etc.; (3) closing the screening process and changing the status of mentors to “ready to be matched.”

Screening is typically carried out by administrative users such as SA, NA, MA, or PA users. Additionally, system 100 may provide tools to aid the screening process. Example tools may allow the users to readily identify users with the “screening incomplete” status, and then display information regarding such individuals, such as the user profile, personal information, evaluation information, matching information, references, status and rating information.

Within a screening tool, an administrative user may select an individual user from a list and click on user's name to access the user's profile. Thereafter, the administrative user may click a button to conduct mentor screening, view a list of references and reference contact information for the prospective mentor. Reference notes may then be added to the appropriate reference, and the notes may be saved. The administrative user may subsequently rate the prospective mentor, change the mentor's status from “screening incomplete” to “ready to be matched,” and then exit the screening process. Optional additional notes may also be added to the mentor's profile under a “screening and program coordinator notes” section. A picture of the mentor may also be included in the mentor's profile. The picture may appear, for instance, when other users receive e-mail messages from the mentor.

In addition to the initial screening process, mentors and other members may be monitored by an ongoing management process, which may include a series of screens including, e.g., a mentor's application information, information on the requirements of a corresponding member organization. The primary screens in one example include a mentor references screen and a mentor status and rating screen. An administrative user may use these tools to view a mentor's profile, choose mentor screening, and view mentor references. The administrator can then check each of the references, either offline or via e-mail and then enter notes for each of the references. Next, the administrative user may save the mentor references form, and navigate to a rating screen. On this screen, the administrator may then enter a note, change the mentor's user status (active, incomplete, inactive rejected, inactive withdrawn, or inactive deleted). Finally the mentor's rating can be updated (matched, ready to be matched, screening incomplete, or application incomplete) and a score (1, 2, 3, 4, or N) may be entered for the mentor.

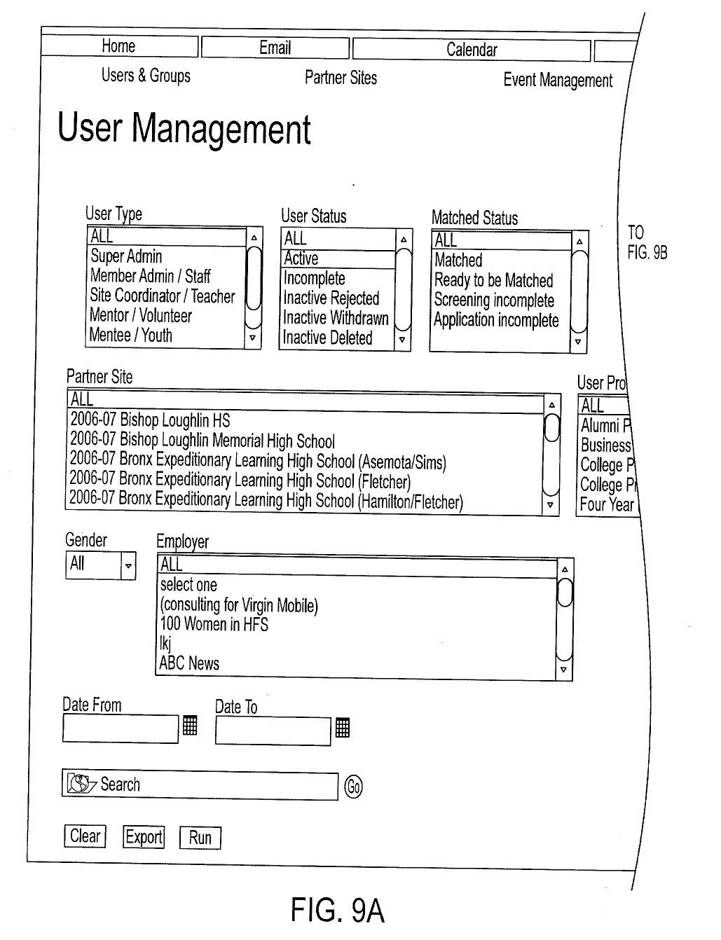

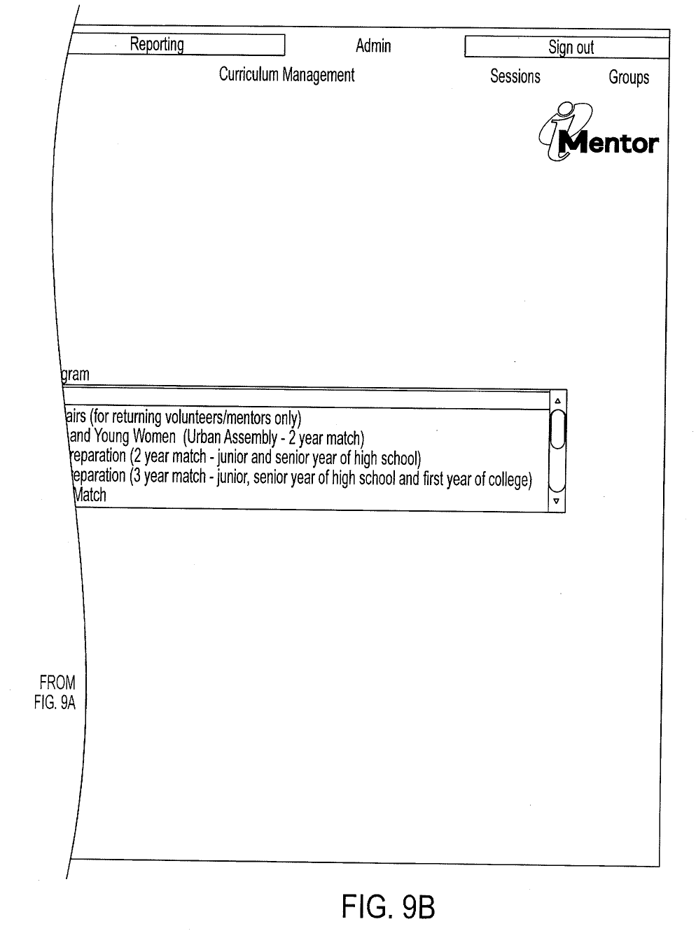

System 100 may also allow back-end users to manage other users through an interface such as that illustrated in FIGS. 9A-9B. As an example, an administrative user may run reports to search for individual users or groups of users based on program preferences, statuses, partner sites, gender, employer, application submit date and keyword. As soon as users begin an application, all information is saved and can be accessed through the interface. As indicated in FIGS. 9A-9B, such information can be accessed by interacting with graphical elements, such as drop-down menus and buttons. For instance, an administrative user may click on administrators/users and groups, select one or more user types, user statuses, and match statuses, and select one or more partner sites, user programs, and employers. Once this information is selected, a report can be run based on the selections. After the report has been run, the page will refresh and show a list of users per the specified search parameters. Additional widgets can be provided for rearranging or further filtering the displayed results.

User management, such as that illustrated in FIGS. 9A-9B, is commonly used to manage mentor/mentee recruitment and screening processes, identify the number of participants with “application incomplete” status, “screening incomplete” status, “ready to be matched” status and “matched” status, discover how many mentors or mentees signed up in a given time period (use a “date range” search filter). It is also used to gain quick access to an individual's user profile, enter a user's name into a search bar to view a single user account, create an e-mail list for external e-mail accounts, or run a report and then export the result to a spreadsheet or copy the e-mail address and send an e-mail. Member management can also be used to run a quick report on number of volunteers by employer, report on partnerships or corporate funding opportunities.

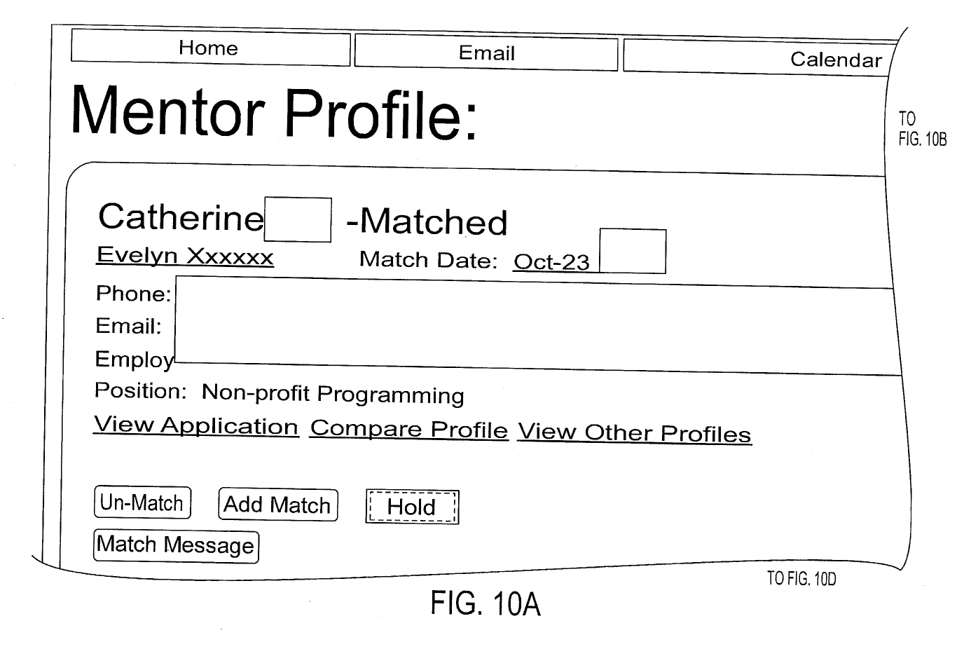

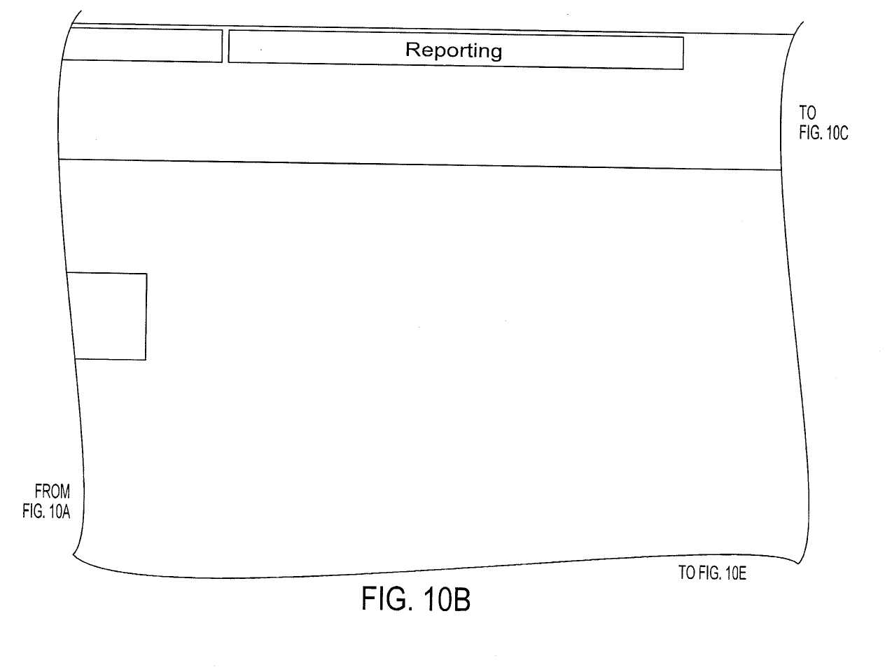

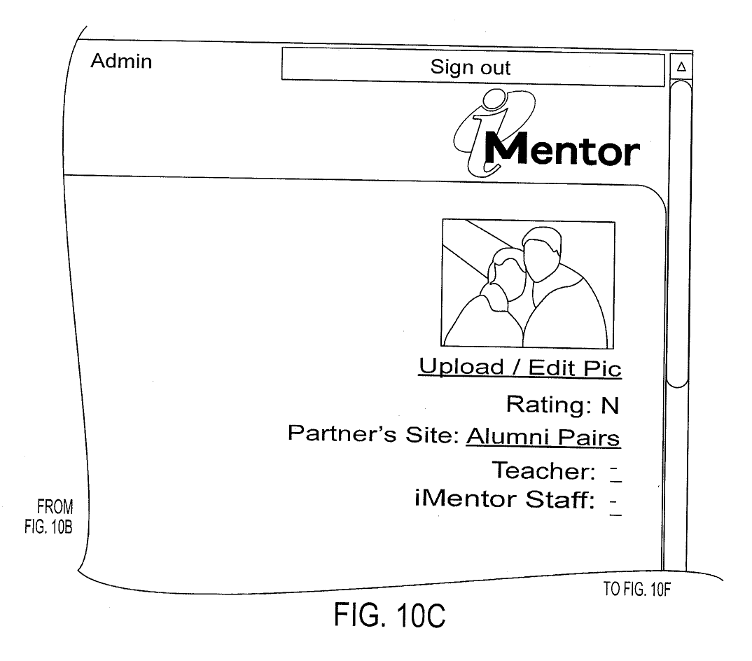

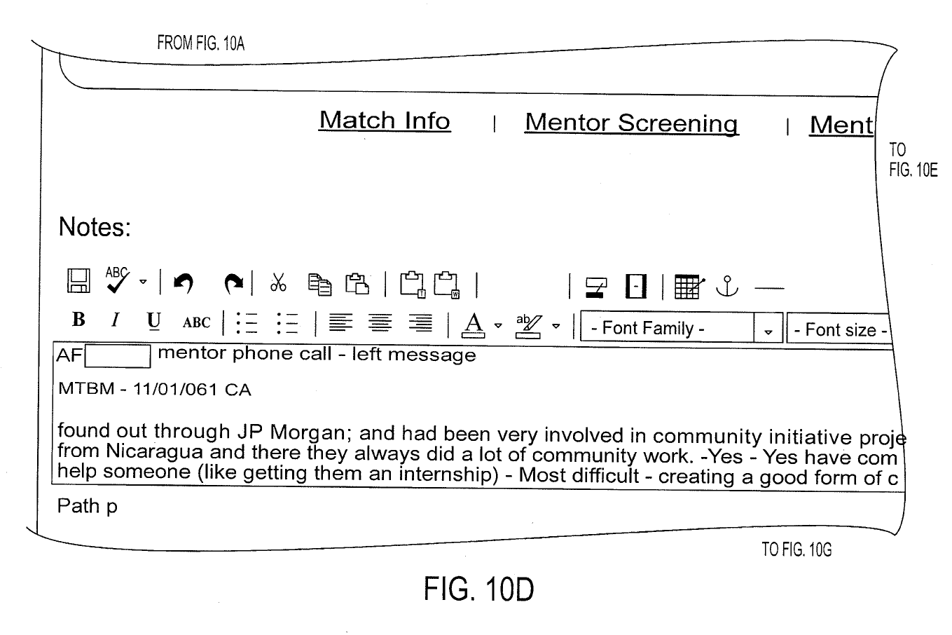

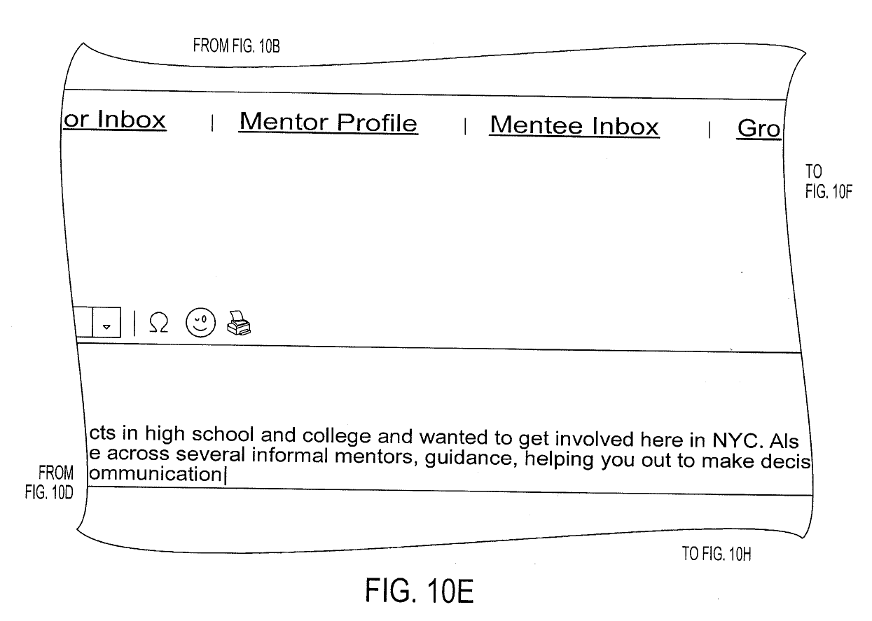

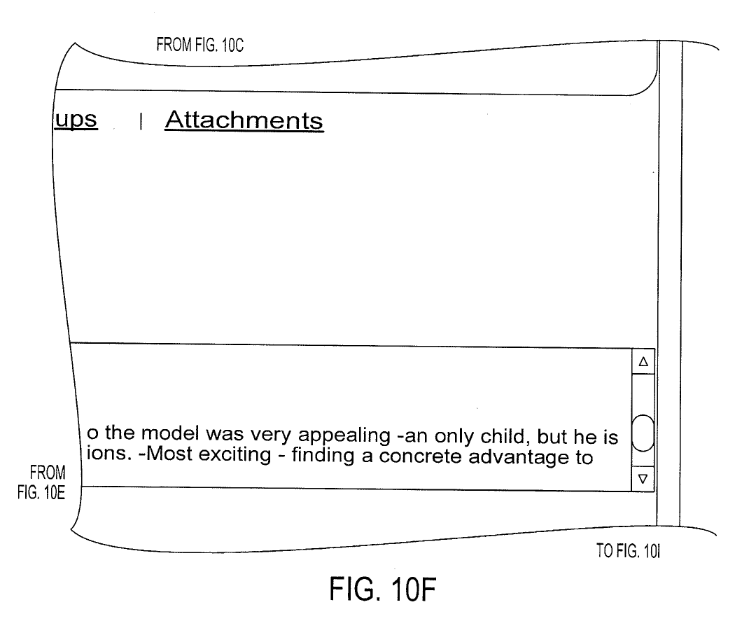

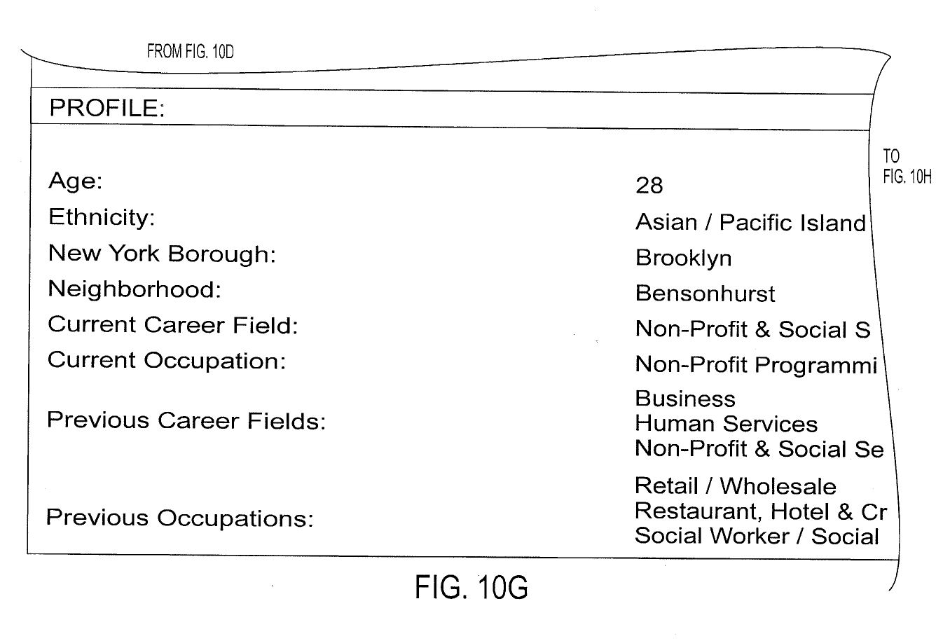

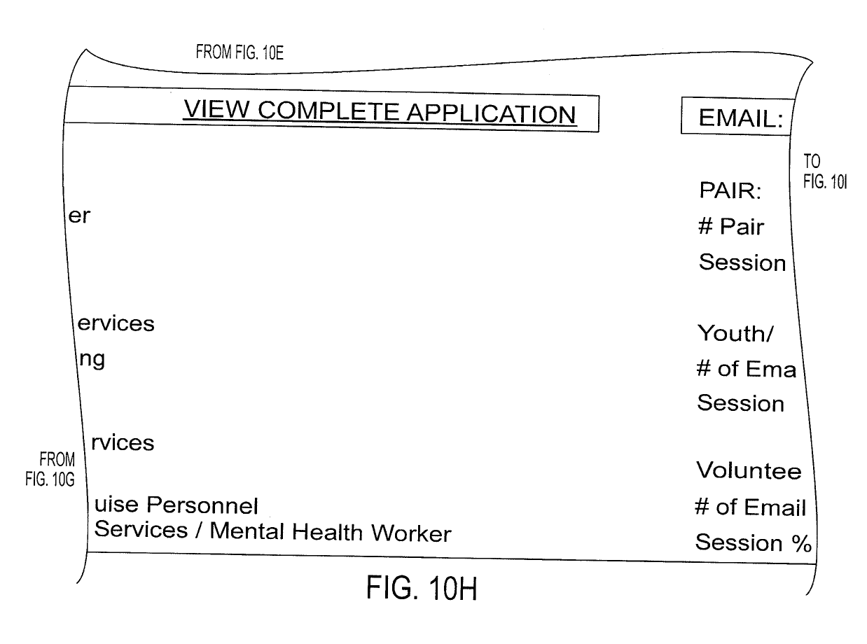

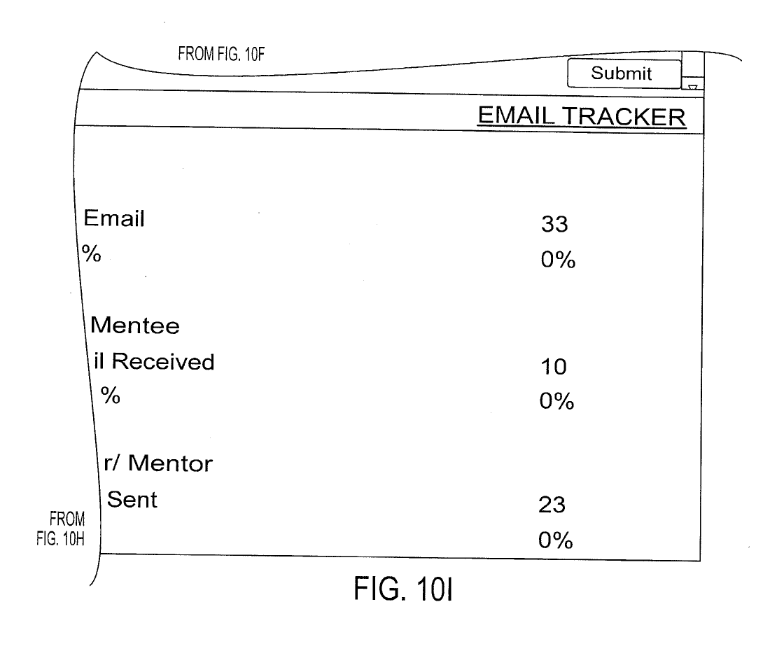

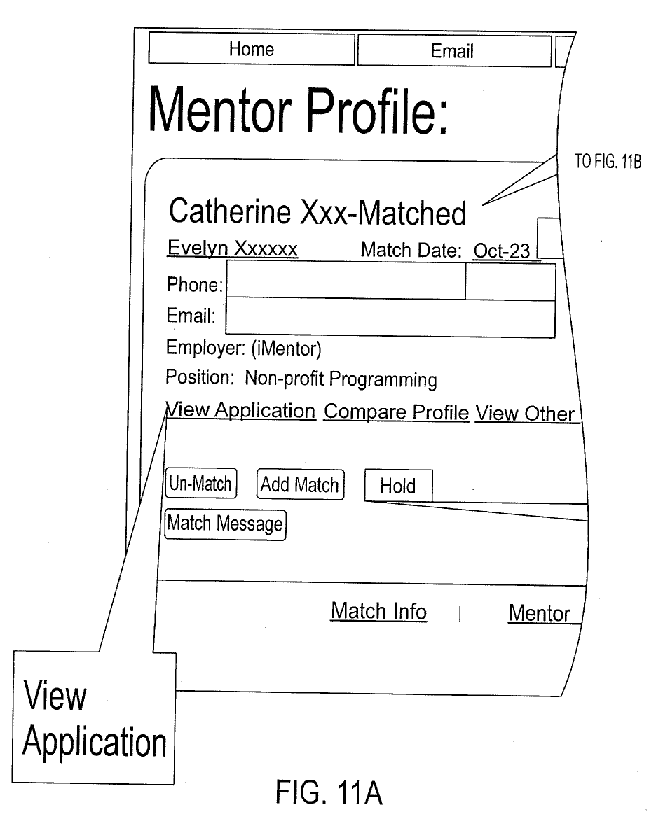

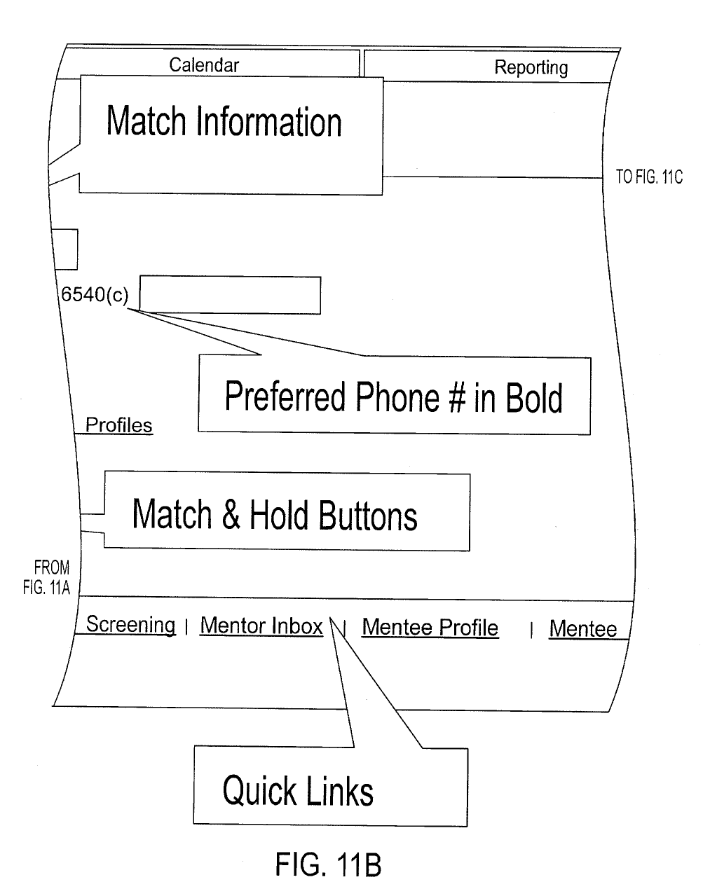

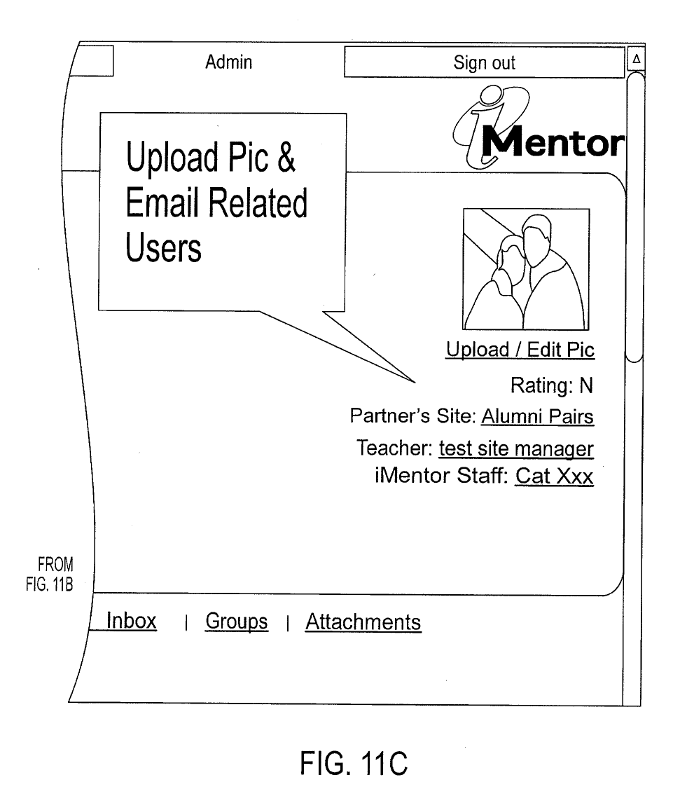

FIGS. 10A-10I and 11A-11C illustrate a mentor profile that may be viewed via system 100. The mentor profile allows convenient access to information about the mentor. Such information may be useful, for instance, to back-end users monitoring a mentor, or even to an existing mentee. As shown in FIGS. 10A-10I and 11A-11C, the displayed information may include, for instance, a photo, name, contact information, and other background data about the mentor. In addition, administrative users may add comments or other information regarding the mentor, and other attachments may be associated with the mentor and included in the profile view. The mentor profile may also provide an indication of the history and recent activity by the mentor, such as communications and events.

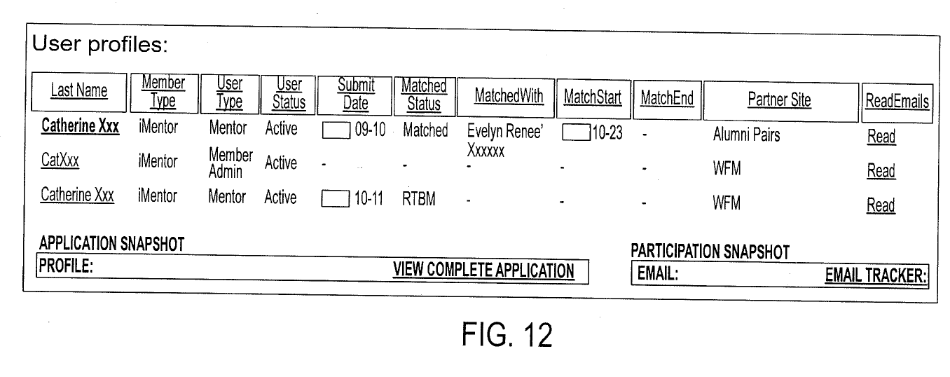

FIG. 12 illustrates multiple profiles associated with a single user. Multiple profiles may be used, for instance, when a user is involved in multiple mentorship relationships, such as a single mentor who mentors multiple mentees.

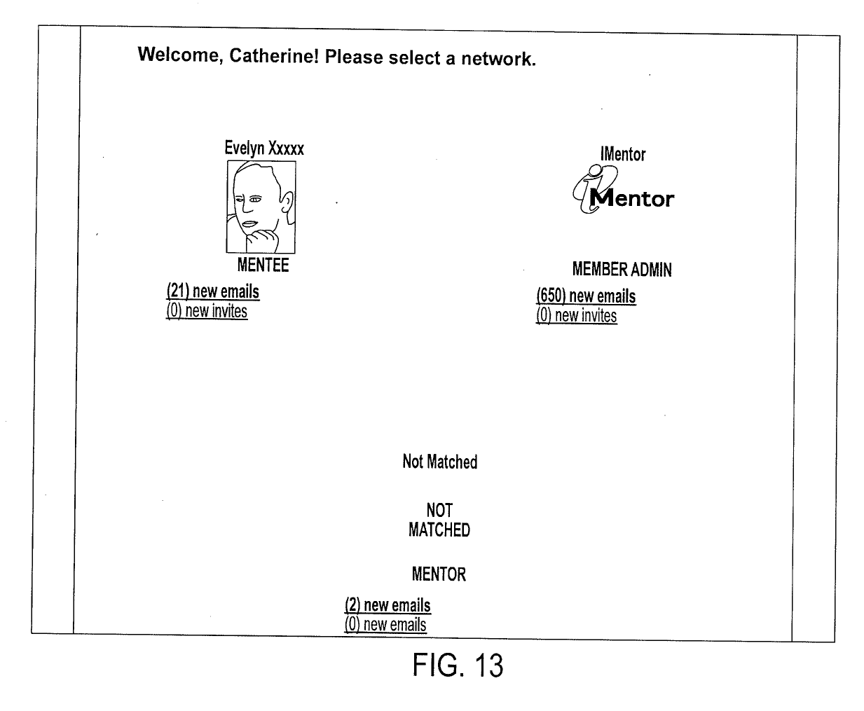

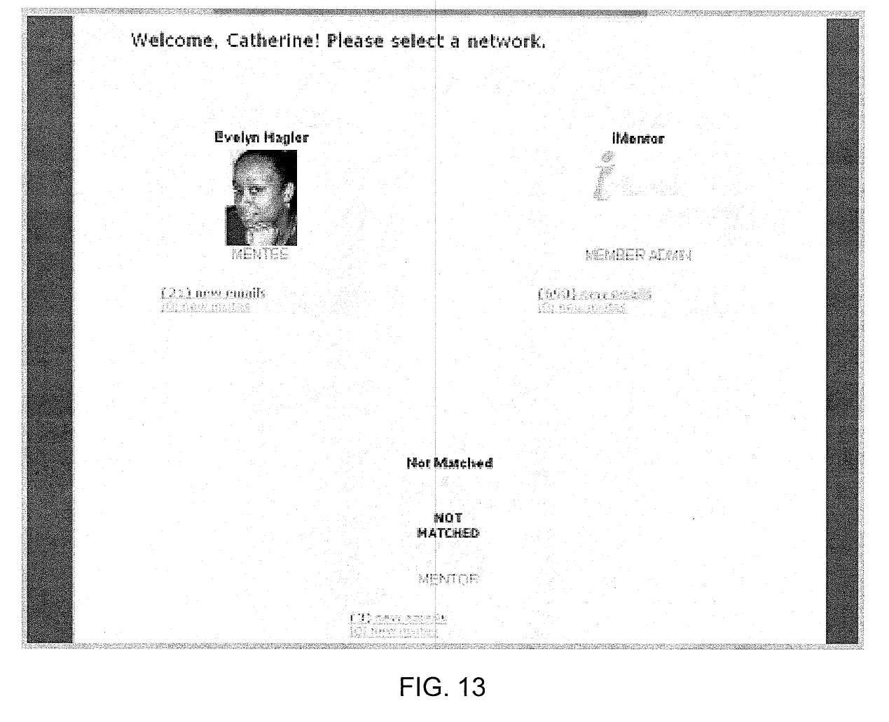

FIG. 13 illustrates a login screen for a user having multiple profiles. As illustrated by FIG. 13, the user profiles may have different types (e.g., SA, mentor, mentee, etc.), they may be associated with different members, and so on. A user can choose to login under any of the different profiles by making an appropriate selection from the login screen.

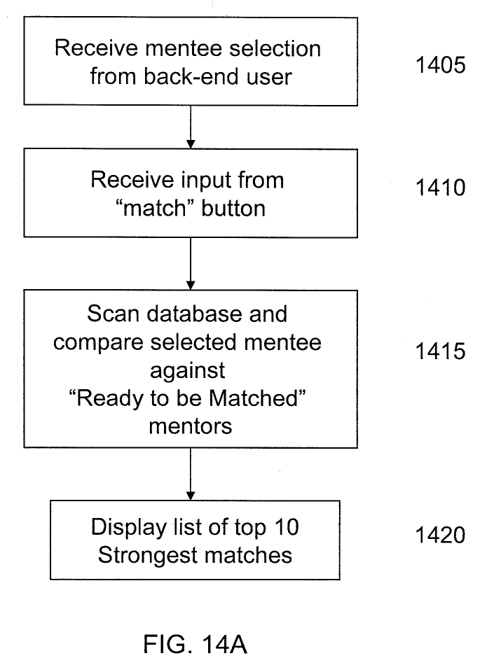

FIGS. 14A-14C illustrate example methods for matching mentors with mentees. The example of FIG. 14A includes steps for generating potential matches, the example of FIG. 14B includes steps for selecting a match from among the potential matches, and the example of FIG. 14C shows steps for interacting with a GUI display to show potential matches.

Referring to FIG. 14A, system 100 receives a mentee selection from a back-end user (1405). The system then receives input from a “match” button (1410). This input may be provided when the back-end user clicks on the match button within a “user management” interface. Next, system 100 scans a database and compares the selected mentee against potential mentors with the status “ready to be matched” (1415). Then, after scanning the database, system 100 displays a list of the top ten strongest matches identified (1420). The relative strength of the matches can determined by a numerical “strength of match” score derived from comparisons of mentor and mentee profiles.

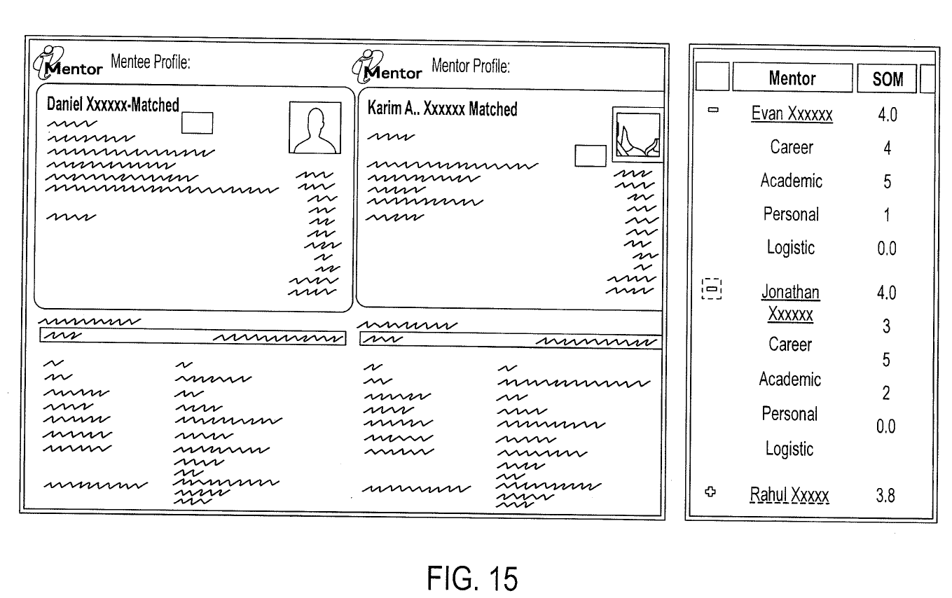

Referring to FIG. 14B, a back-end user, such as an SA or MA user, may click an icon in a mentor or mentee profile to view candidate matches and/or corresponding strength of match scores (1455). FIG. 15 shows, on the right side, examples of displayed strength of match scores. The back-end user may also examine and compare the user profiles for potential mentee/mentor matches (1460). FIG. 15 illustrates a side-by-side comparison of a potential mentor/mentee match. By viewing profiles in this manner, the back-end user may better evaluate the potential compatibility of the mentor and mentee.

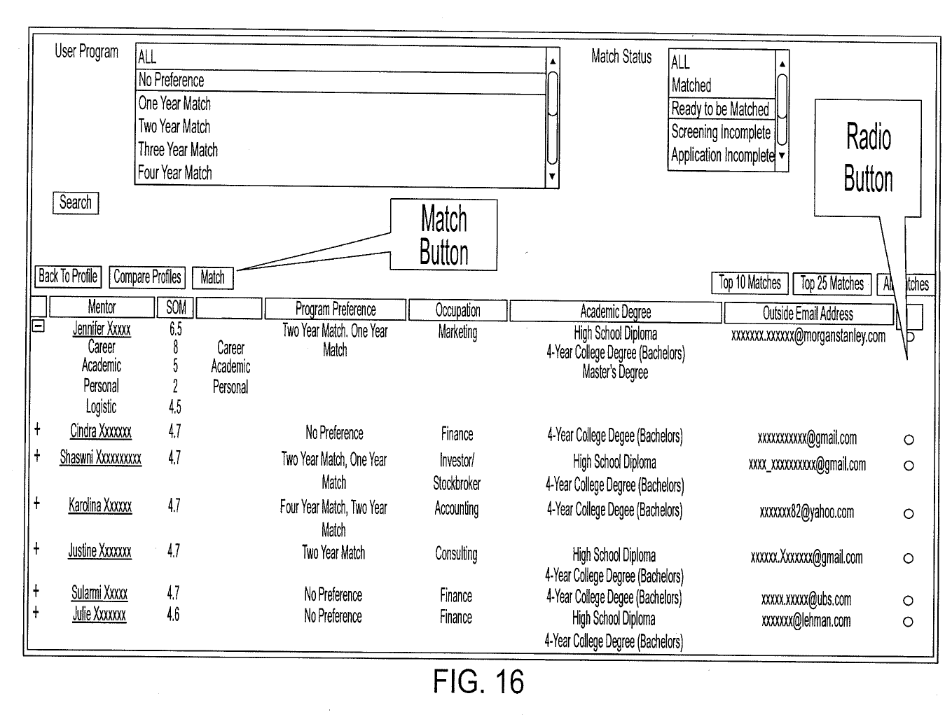

Referring to FIG. 14C, the back-end user may click on a radio button such as that illustrated in FIG. 16 to view additional details or profiles of displayed mentors (1465). The back-end user may then click a “compare profiles” button to display profiles in a side by side comparison (1470). The back-end user may also simply click on the name of an individual mentor to see the mentor's profile (1475). The back-end user may also click a button to display only the top 25, or all matches for a particular mentor or mentee (1480). Finally, the back-end user may employ a filter to search for matches satisfying certain custom criteria (1485).

FIG. 16 illustrates a “match” button that can be used to assign a specific mentor to a specific mentee. As indicated in FIG. 16, the back-end user may select a mentor by clicking a radio button and then clicking the match button. Such a selection can be made from among a list of mentors such as that displayed in FIG. 16, which is displayed in accordance with the settings on a drop down menu. When a mentor is assigned to a mentee, information stored in system 100 is updated to reflect the assignment. For instance, both mentor and mentee match status may be changed to “matched,” the mentor and mentee may be added to each other's address books, allowing them to e-mail one another, the mentor may be assigned to the mentee's partner site, the mentor and a teacher assigned to the partner site may be added to each other's address books, allowing them to communicate via e-mail, the mentor may be added to the Partner Site's Class List, E-mail Tracker, Event Tracker, etc., and system 100 may generate mentor and mentee match messages in a pop-up window.

After a mentee and mentor are matched, system 100 may automatically generate and send a “match message” to the mentor and mentee. A match message may introduce the pair by sharing some basic information between the two of them. It may, for instance, pull out key details from mentor and mentee applications, and it may also include some fun facts. In some embodiments, a back-end user may review and possibly edit the match message before it is sent.

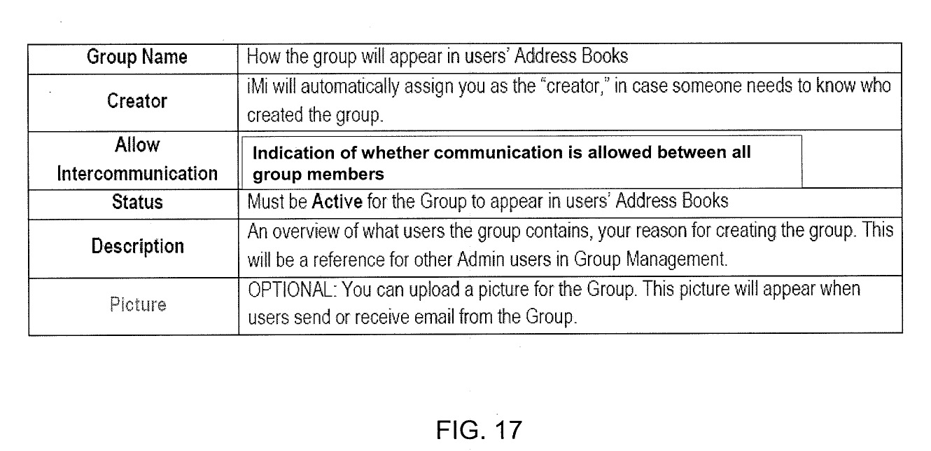

FIG. 17 shows a table of values that may define groups of users and indicate interactions that can be performed by members of the groups. These definitions are part of a feature set within system 100 to allow group and network management. As indicated in FIG. 17, a group may have, for instance, a name, a creator, intercommunication constraints, a status indicator, a description, and a picture.

In general, group management functions may involve at least (1) defining default networks, (2) group management, and (3) expanding networks by creating groups. These functions are typically performed by administrative users such as SA, NA, MA, and PA users. These functions may be performed through various pages in a GUI, such as a group management list page, or a group profile page.

A default network defines the basic access level of different types of users within system 100. The names of users in a user's default network automatically appear in an address book of the user's e-mail account. By default, an MA user may have access to all participants, including, all other MA users for their organization, all teachers, all mentors, and all mentees. A teacher, by default, may have access to all participants enrolled at his/her partner site, a MA user assigned to the partner site, mentors assigned to the partner site, and mentees assigned to the partner site. Mentors and mentees, by default, have access only to MA users assigned to the partner site, teachers assigned to the partner site, and mentors and mentees with whom they are matched.

Each partner site typically has three groups automatically created by system 100: 1) a group including all of the site's users; 2) a group including all of the site's users mentors; and 3) a group including all of the site's mentees. These groups are automatically updated when new users are assigned to a partner site. Only MA users have access to the automatically created groups for the partner sites to which they are assigned.

Group management tools in system 100 allow back-end users to search, monitor and manage the groups in the network. A back-end user can access the group management tools, for instance, through a graphical user interface. The tools may allow the back-end user to perform functions such as searching auto-created groups, creating groups, searching groups created by staff such as SA users, edit group profiles, e.g., by adding or removing members, changing permissions or e-mail groups, viewing group enrollment, and delete groups. The tools may also allow back-end users to create expand participant networks by making “created groups.” Creating a group adds users to each other's address books, allowing them to send e-mails, event invitations, etc. Such a group can be created, for instance, by clicking a series of buttons and entering data in fields within a GUI.

Group management features also allow back-end users to regulate “intercommunication” between members of any given group. To allow intercommunication among group members, the back-end user may simply check an “allow intercommunication” button when creating the group. If intercommunication not is allowed, a listserv may still be created for group members, allowing members of the group to communicate with the group as a whole, but not with individual group members. Such listserv communications may be available only if the group name appears in group members' address books. If intercommunication is allowed, however, system 100 may allow both “all group” communication (e.g., via listserv), and individual communication. In addition, all individual contacts in the group may be added to group members' address books. In addition, system 100 may also include 1-way groups, which are groups of users who can all see a leader in their address book, but can not see each other.

The users of system 100 may have safe and secure e-mail accounts. These accounts may function as traditional web-based e-mail accounts, with the exception that they may be tailored for building safe, quality mentor-mentee relationships. Additionally, users may not have access to addresses outside of system 100 through the e-mail accounts, and all e-mail communications may be tracked and logged in a database within system 100.

These e-mail accounts may function like traditional web-based e-mail systems by allowing users to log-in to their accounts from anywhere they have internet access to send and receive e-mail messages. As distinguishing features, however, the e-mail accounts may include address books regulated by back-end users and automated processes within system 100. They may also include writing prompts to provide ideas to mentors and mentees on how to conduct conversations.

To provide safety and security, users may be restricted to interacting only with people in their network, mentees may be restricted to connecting only with mentors and volunteers that have met screening and training requirements. Also, e-mail aliases may be used instead of actual e-mail addresses to prevent users from knowing other users' outside e-mail addresses. To send e-mails, users may select e-mail recipients from a list of names in their address book. Messages sent in system 100 may be logged in an e-mail log, where they can be screened and monitored by administrative staff.

Various e-mail monitoring tools may be used to track the frequency and regularity of communication between mentors and mentees. Such measurements may provide key indications of the success of mentoring relationships. Tracking data can be viewed and analyzed by administrative staff with an easy way to measure communication against participation benchmarks and real-time identification of pairs who need further intervention.

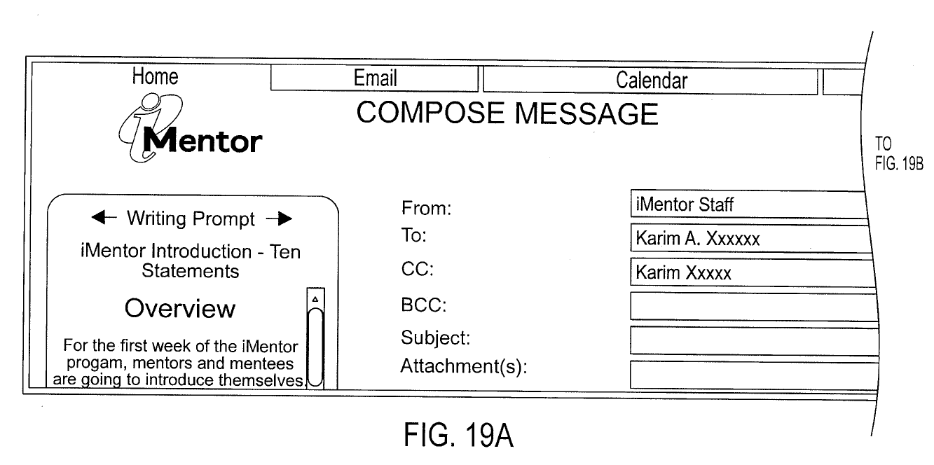

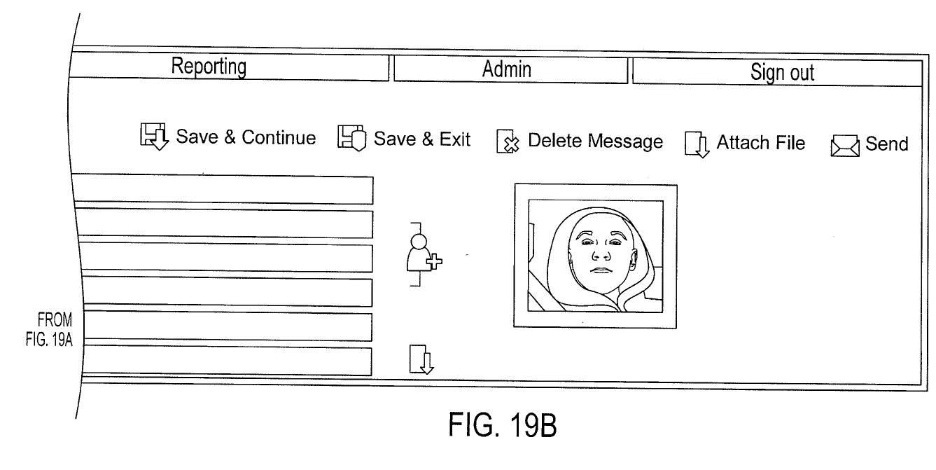

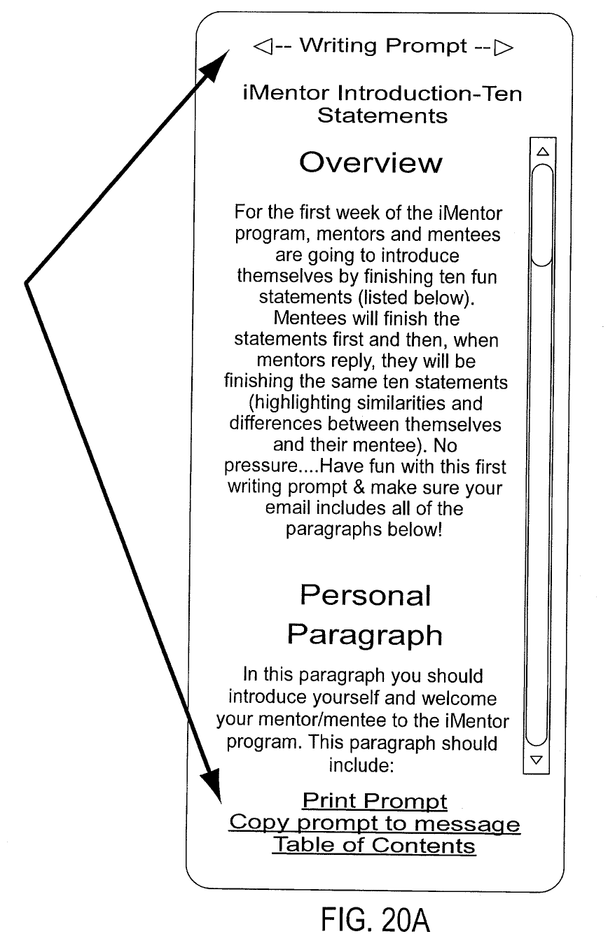

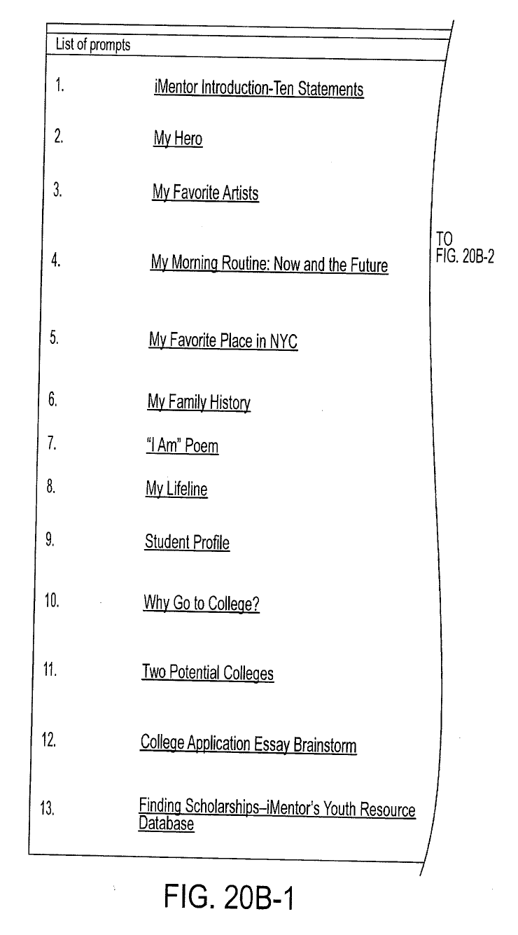

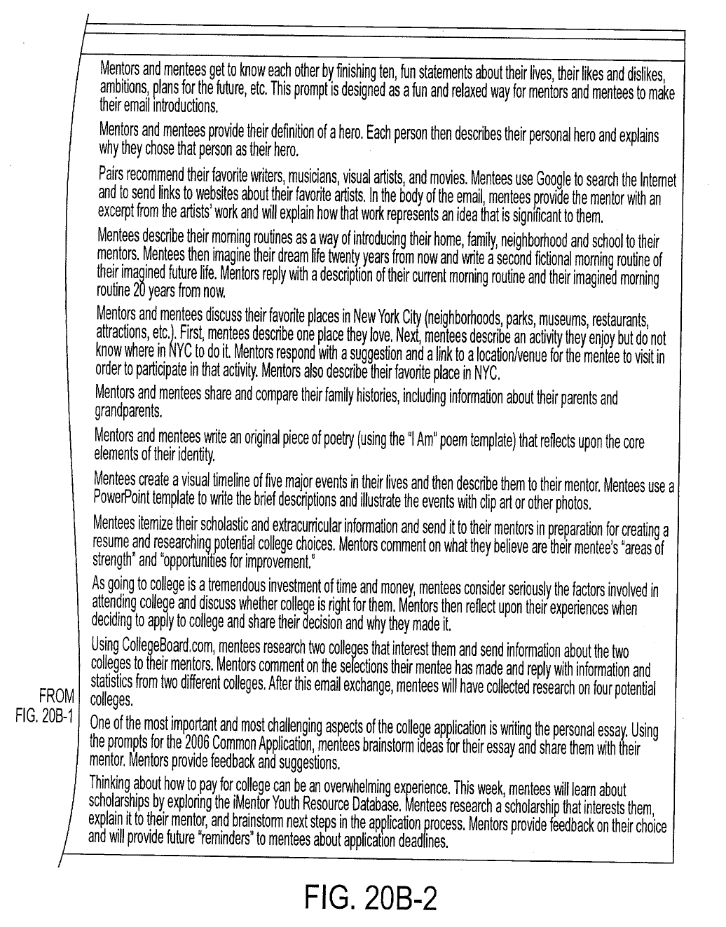

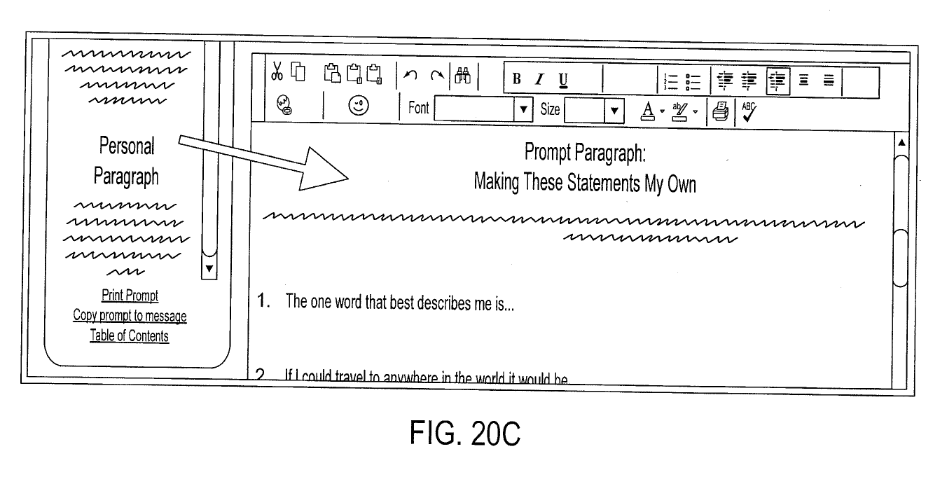

E-mail communications between mentors and mentees can be aided by the use of writing prompts. Such writing prompts may be integrated into the e-mail system, appearing next to a text box where mentors and mentees compose messages. An example writing prompt is illustrated in FIGS. 19A-19B and 20A-20C. Additionally, pictures may add a personal touch to users' e-mail accounts, allowing participants to see who they are writing to and receiving messages from.

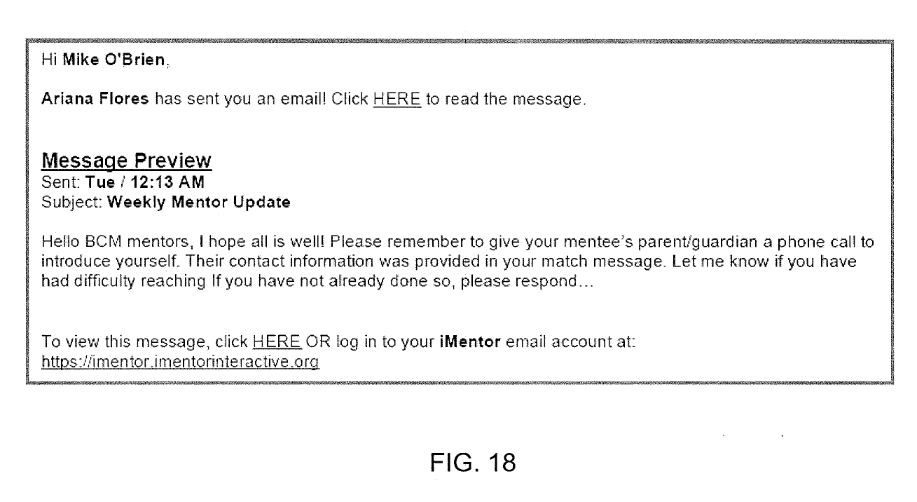

FIG. 18 illustrates a new e-mail notification, which may be sent to e-mail recipients and provide access to the message itself. In some embodiments, every time a user is sent a new e-mail, a notification is received in the user's outside e-mail account. In other words, the notification is forwarded to a personal e-mail account outside of system 100. Such notifications keep users up-to-date about new e-mail, provide users with previews of the messages and links to the system 100 e-mail account log-in.

FIGS. 19A-19B illustrate a graphical user interface for composing e-mail messages within the context of system 100. Users can compose messages by clicking on the “compose message” button or replying/forwarding an existing message. This brings up the compose message screen. A user may add recipients to an e-mail message by populating fields in the interface shown in FIGS. 19A-19B. A user can also add a recipient by making a selection in an address book. Such additional recipients can be identified, for instance, by entering a text search for specific contacts or groups. Additionally, the user can change a “view mode” drop down to view groups instead of contacts, add or remove contacts or groups, use a list-sort function to reorganize contacts, click an expand (“+”) icon to see individual contacts from a group, and so on. When a user is finished adding recipients from the address book, the user may click back to a message. E-mail users can also add attachments to e-mail messages by using tools provided in a graphical user interface.

FIGS. 20A, 20B-1, 20B-2 and 20C illustrate various tools that may provide structure for a mentoring relationship and may assist mentors and mentees in their communications with each other. In particular, FIG. 20A shows an example writing prompt, FIGS. 20B-1 and 20B-2 illustrate a set of topics that may be used in different writing prompts, and FIG. 20C illustrates an editor for entering information based on the writing prompt.

The writing prompt shown in FIG. 20A instructs mentors and mentees to provide introductory information to each other. The writing prompts in FIGS. 20B-1 and 20B-2 include various topics that can be discussed in successive communications. The writing prompts and other tools may be accompanied by guides and suggestions for how to prepare communications, address a particular topic, etc.

A mentor or mentee can use these tools by simply following guides for mentoring-specific e-mail conversations, browsing different prompts using forward and back arrows, printing prompts, copying the prompt into the body of their message, browsing prompts in a table of contents, clicking on a prompt title within the table of contents, such that the prompt is auto-filled in a form such as that shown in FIG. 20C.

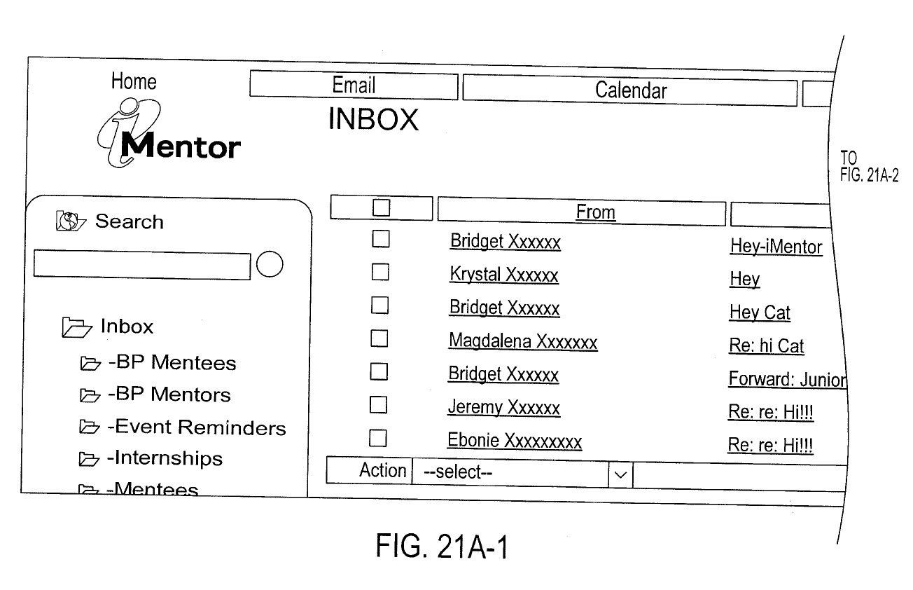

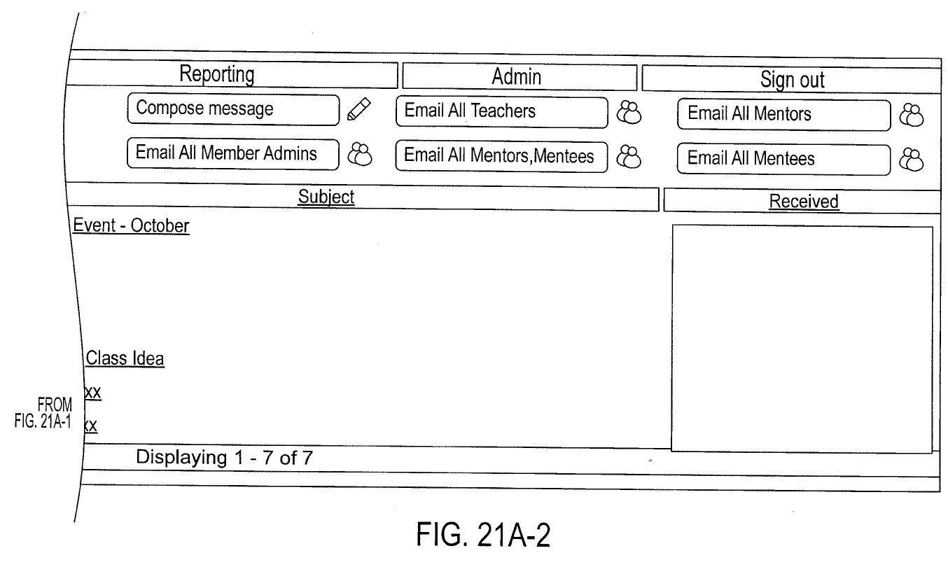

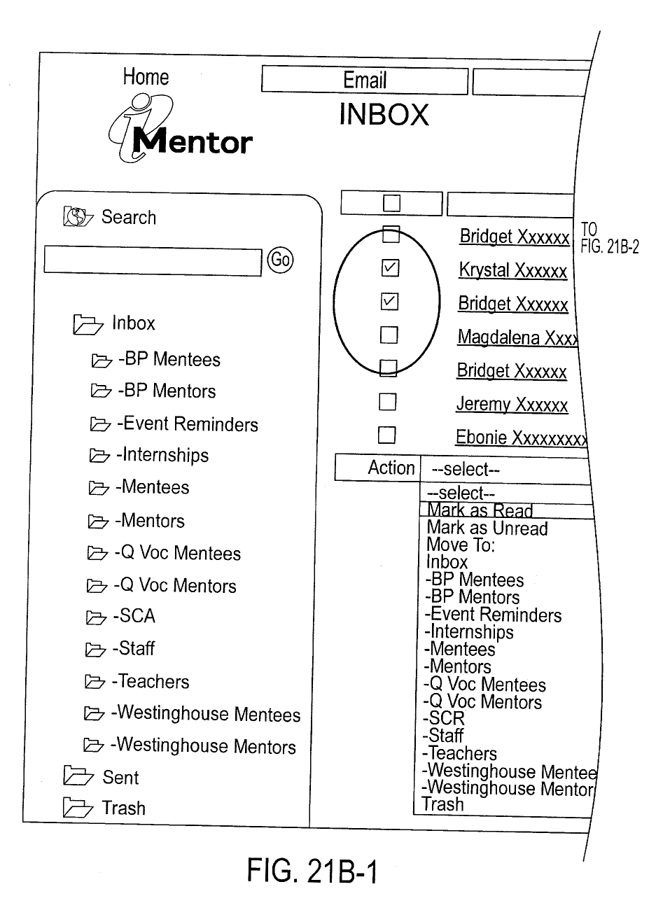

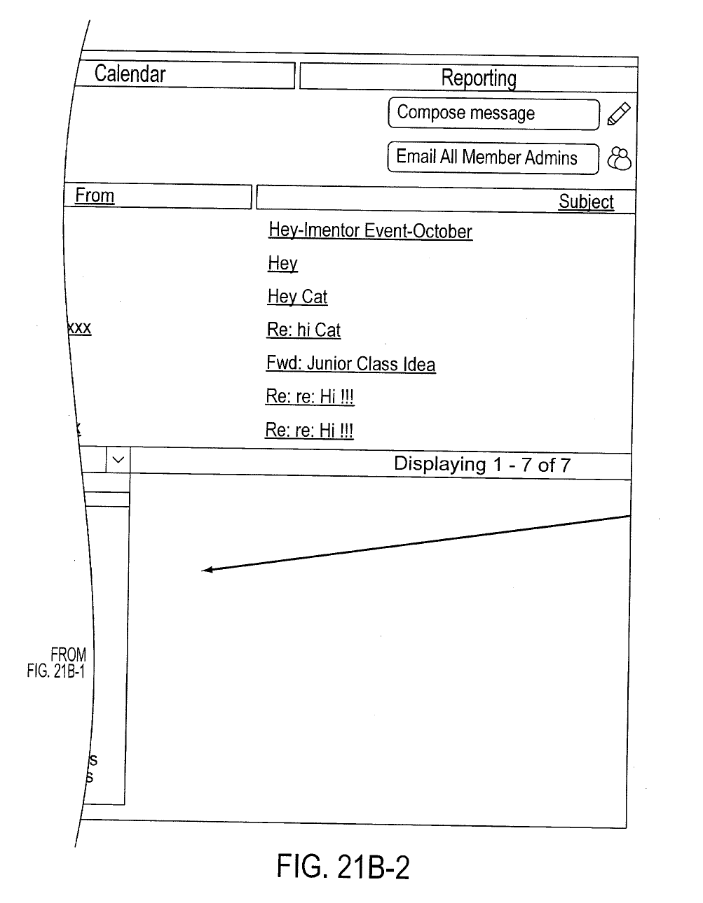

FIGS. 21A-1, 21A-2, 21B-1 and 21B-2 illustrate example techniques for managing e-mail messages within system 100. As one example, users can organize and store e-mail messages using a folder manager such as that illustrated in FIGS. 21A-1 and 21A-2. The folder manager may allow users to add, edit and delete sub-folders in the inbox. Additionally, users can file e-mails in the folders, text search the messages, use e-mail quick link buttons to contact all mentors, all mentees, all teachers, and all MA users. As another example, users may manage e-mail messages using a drop-down menu system such as that illustrated in FIGS. 21B-1 and 21B-2. Such a system may allow users to mark messages as “read” or “unread,” file messages in sub-folders, delete messages, and so on.

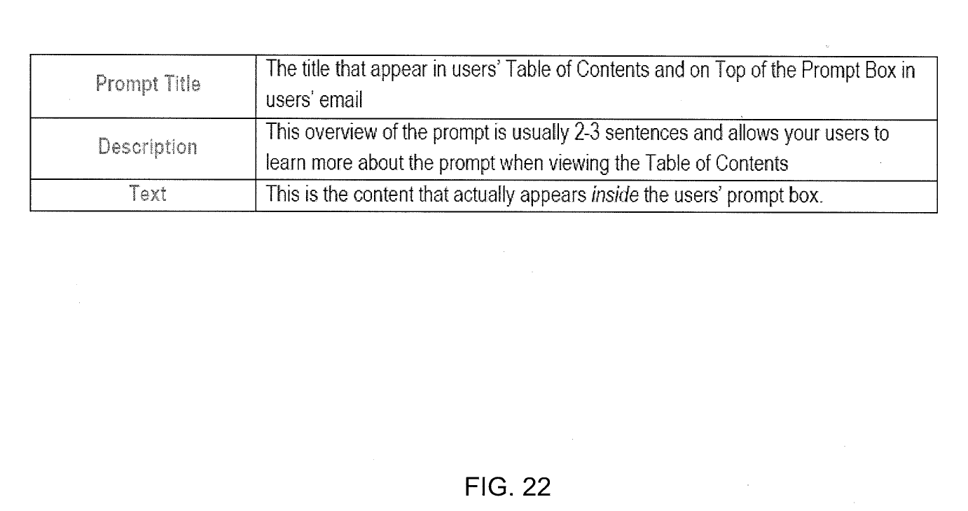

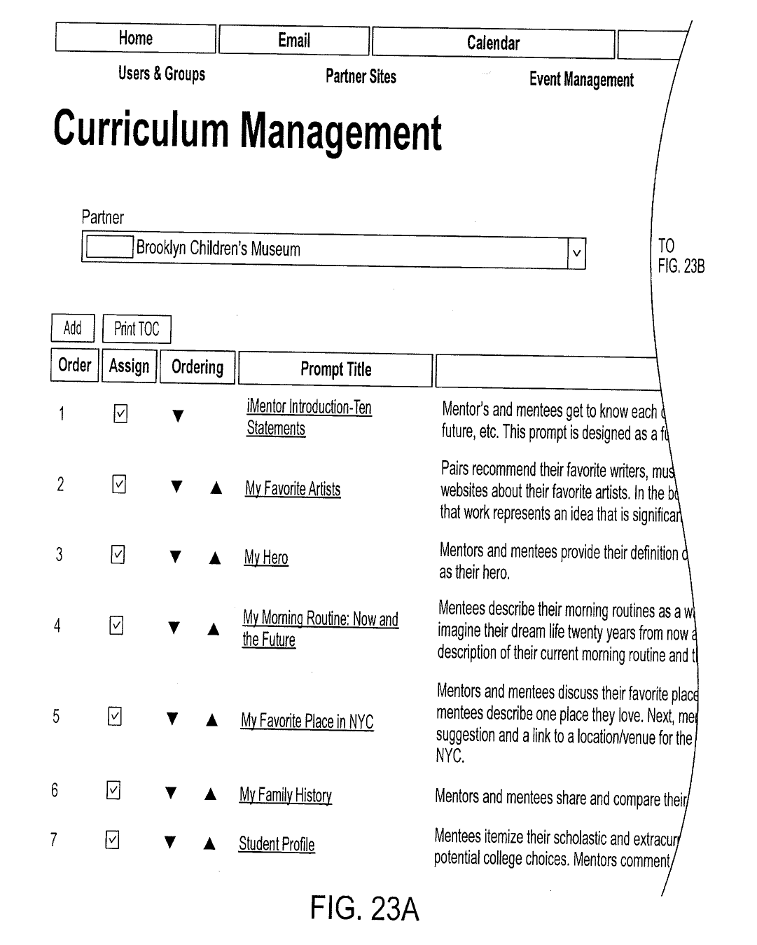

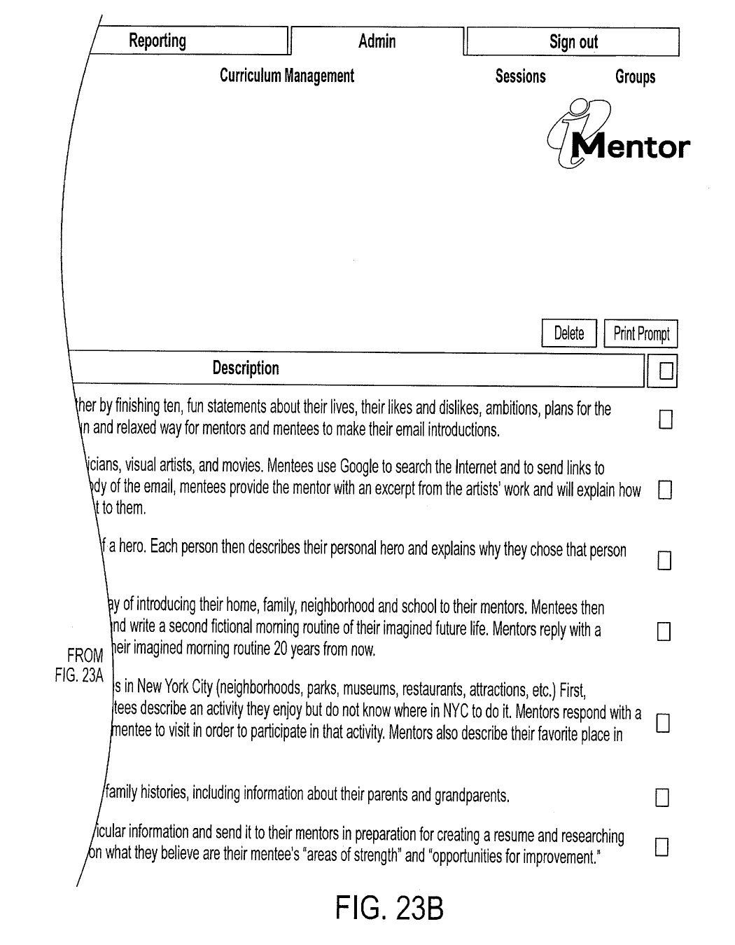

FIGS. 22 and 23A-23B illustrate features and tools that may be used to manage a mentoring curriculum for mentors and mentees. These tools may allow administrative users, such as SA, NA, and MA users, to organize specific curriculum tasks for partner sites. They may do so, for instance, by creating writing prompts and distributing them to users.

A custom writing prompt may be created through a graphical user interface providing fields for entering information such as a prompt title, description, and actual prompt text. A prompt may then be assigned to a partner site before any users can access the prompts. The prompt can be also assigned to a partner site through a graphical user interface, e.g., by selecting a predefined partner site from a drop down menu.

System 100 may further include “sessions,” which are tools that can be used to measure the frequency of e-mail communications between mentors and mentees, and control a curriculum for a partner site. A new session can be created, for instance, when a mentor is assigned to a particular mentee, and the session can be used to monitor and control activities for that relationship. Session management tools allow back-end users to create benchmarks for measuring e-mail communication and assign prompts for specified periods of time.

Since the frequency of e-mail communication may be an indicator of a strong mentor-mentee relationship, sessions are used to measure how regularly mentoring pairs are communicating and follow-up with pairs in need of further support or intervention. Some programs will want participants to communicate weekly, monthly, etc. Sessions provides a flexible way to create benchmarks for communication and measure the performance of pairs against those goals.

Session management tools can be accessed, for example, through a graphical user interface having buttons such as a “create a new session” button or an “edit existing session” button. Typically, both MA and teacher users can create a session, and each partner site may be responsible for their own session management. When a new session is created, three things may happen automatically: an old session may be closed, users may see a new prompt in their e-mail curriculum box the next time they log-in, and a new session column may be added to a partner site's e-mail tracker.

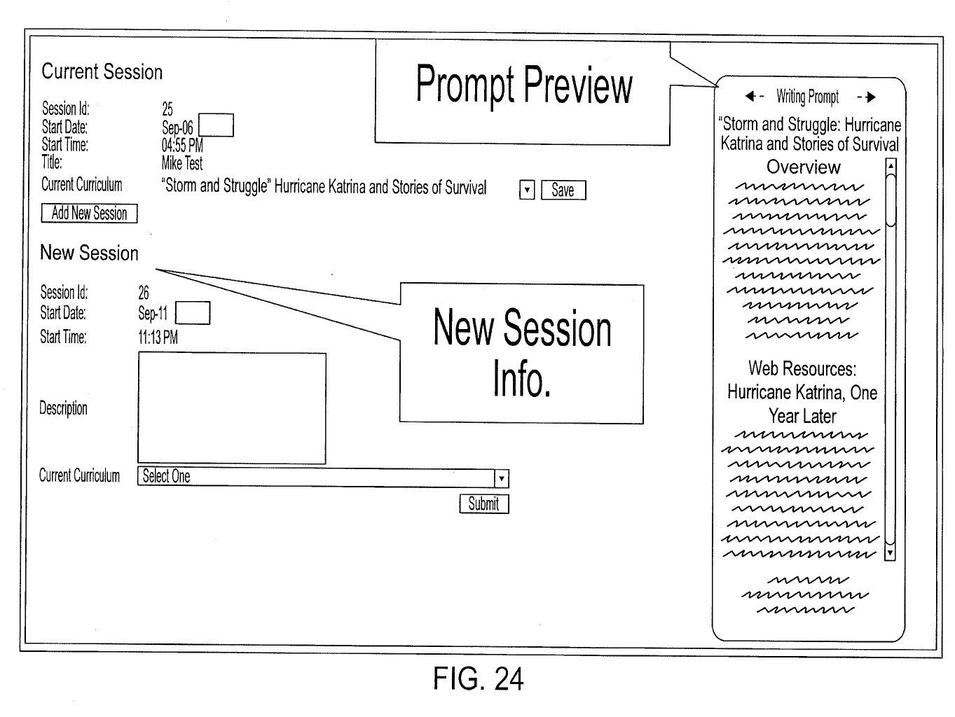

FIG. 24 illustrates one example of an interface that can be used to create a session. Within this interface, a session can be created by first clicking an admin/sessions button and selecting a partner site from a drop-down menu. This will refresh the screen and show a session log for the partner site. Within the interface, the current session may be indicated in bold. The user may then scroll down below a session log, and click “add new session” below the current session. A “new session” dialog will then appear with a date and time pre-filled. Next, a description is entered for the session. The description may appear in a session log and as a title in the administrative user's e-mail tracker. Next, a curriculum prompt may be selected to assign a curriculum to the session. The prompt may appear as a default prompt in a monitored user's e-mail prompt box. The interface will then automatically refresh and show a preview of the selected prompt. Finally, a “submit” button can be pressed to initiate the session.

Sessions can also be edited by changing, e.g., the description, time, date, and curriculum for the session. The session can be edited, for instance, by filling in appropriate fields in a graphical user interface.

Additional e-mail monitoring and tracking functions can be performed by back-end users, such as SA, MA, and NA users. In particular, the back-end users may use a variety of tools to monitor communications between mentors and mentees. Such tools may include, for instance, an e-mail log that automatically collects and organizes information regarding mentor/mentee communications. Back-end users may access the e-mail log to view and/or screen communications. Back-end users can also use the e-mail Log to run reports on e-mail traffic, e.g., by a given date range, a partner site, or user type. Data from the e-mail log can also be exported, for instance, to a spreadsheet program for further analysis. Such data can also be sorted, analyzed quantitatively, and manipulated using any number of data mining or data analysis tools. Back-end users can also add their own notes, flags, or other annotations to the e-mail log. Moreover, they may create custom alerts to notify them if specified events (e.g., messages with key words) are detected within the e-mail log.

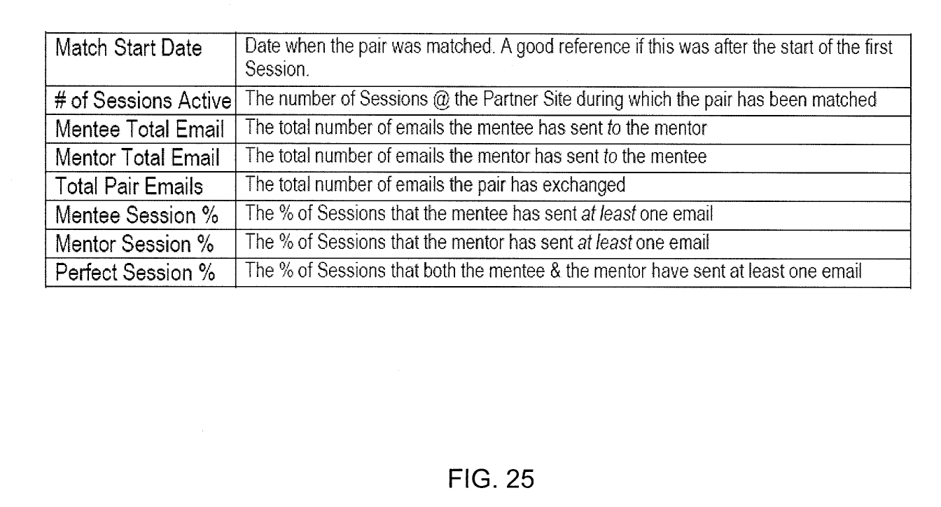

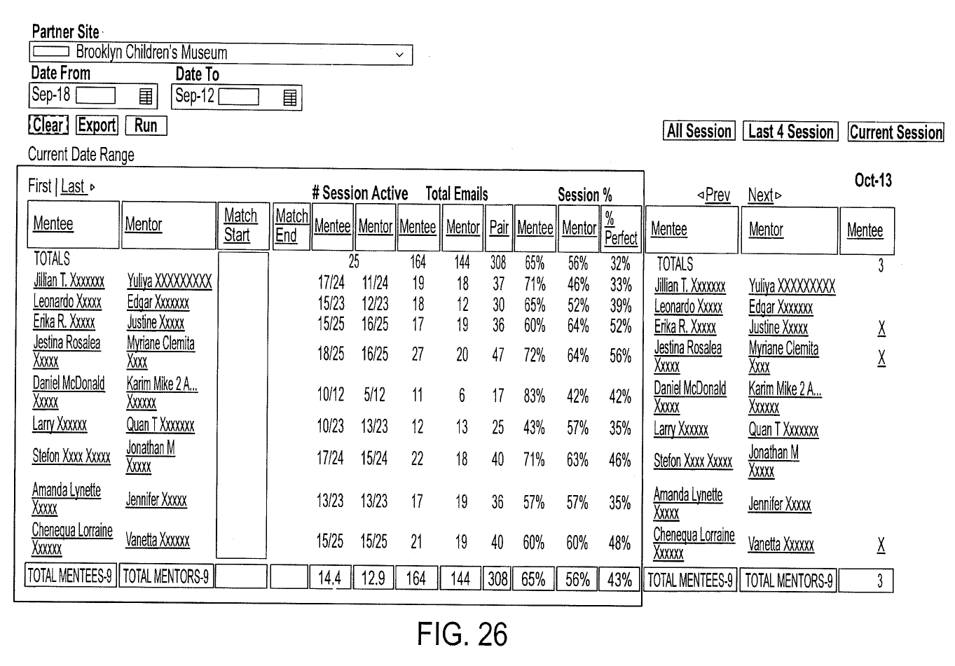

FIGS. 25 and 26 illustrate additional monitoring and tracking tools. Specifically, they illustrate an e-mail tracker that may be used to analyze mentor-mentee pairs. FIG. 25 shows information that may be accessed by a back-end user through the e-mail tracker, and FIG. 26 illustrates an interface through which the back-end user may access this information.

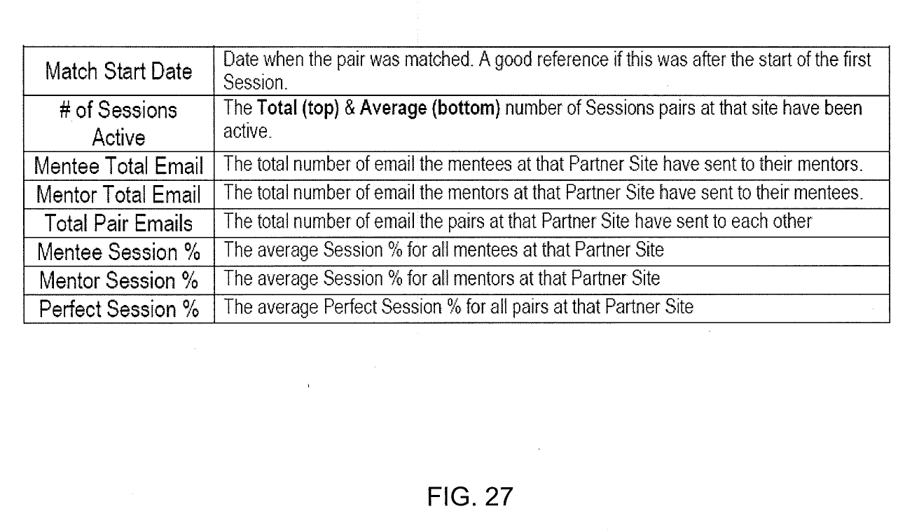

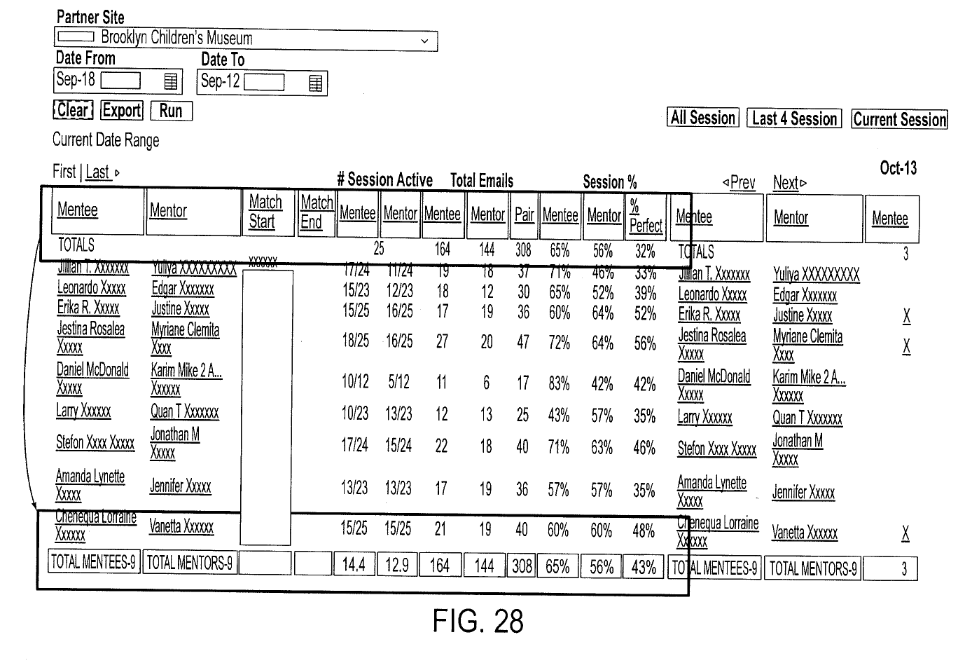

FIGS. 27 and 28 illustrate tools for partner site analysis. In particular, FIG. 27 shows information that can be accessed and analyzed with respect to partner sites. FIG. 28 illustrates an interface in which such information may be accessed, displayed and analyzed.

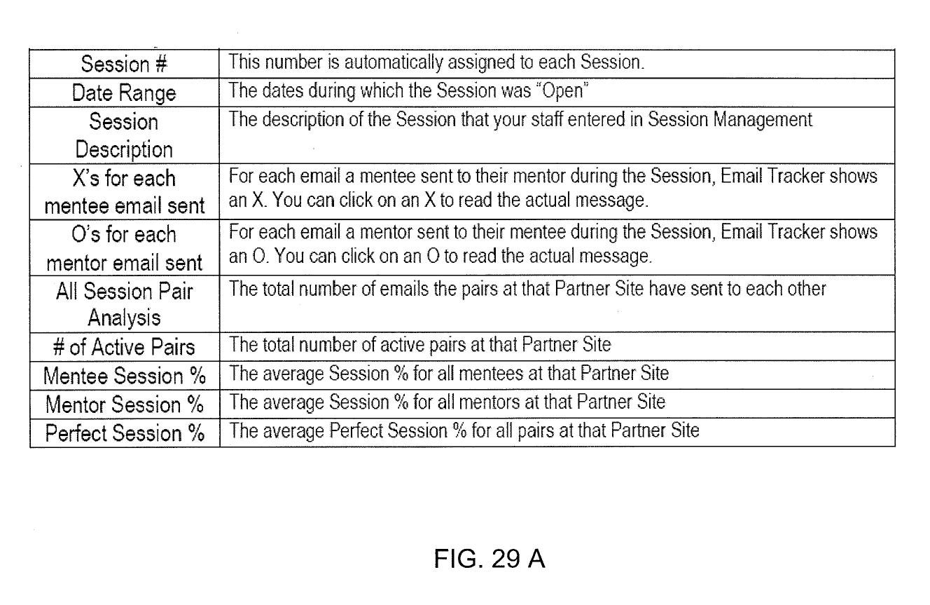

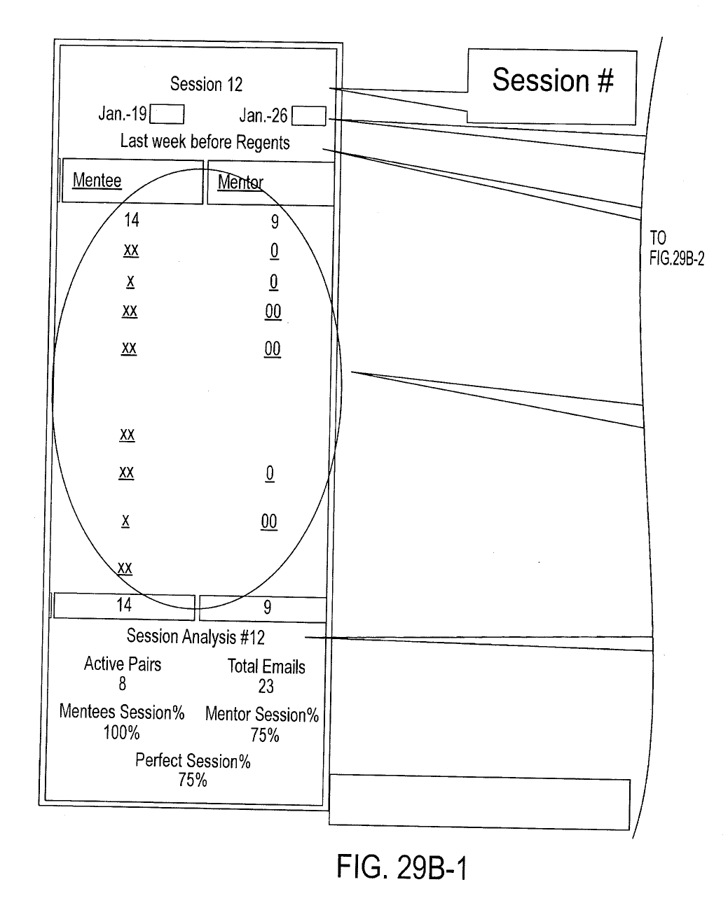

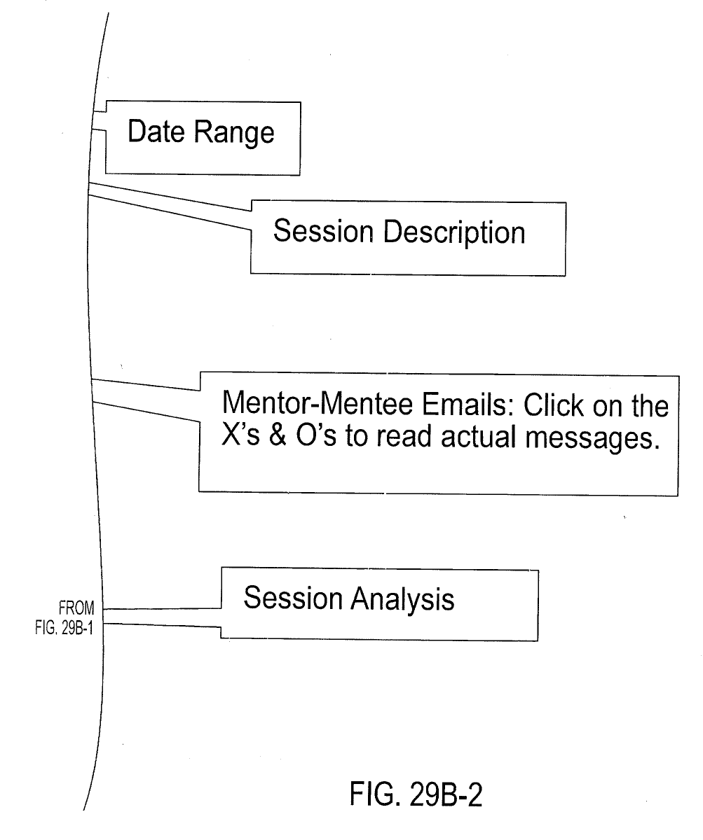

FIGS. 29A, 29B-1 and 29B-2 illustrate tools for conducting session analyses. Such tools may be accessed, for instance, within the interface of the e-mail tracker. FIG. 29A illustrates information that may be analyzed in the session analysis, and FIGS. 29B-1 and 29B-2 illustrate an interface for displaying the information. The tools and interfaces shown in FIGS. 29A, 29B-1 and 29B-2, as well as those shown in at least FIGS. 25-28, may be used to generate reports regarding e-mail tracking and monitoring. Such reports can be generated, for instance, by choosing a portion of the data to process (e.g., a set of sessions, a set of partner sites, a date range) and clicking a “run” button. Such a report, once generated, can be viewed or exported to a spreadsheet.

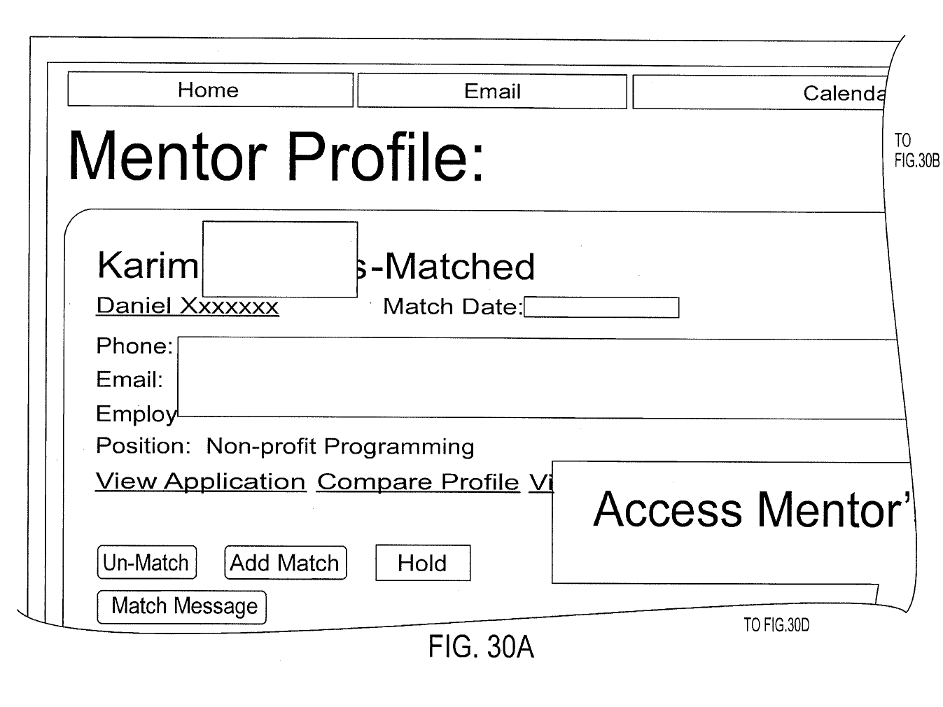

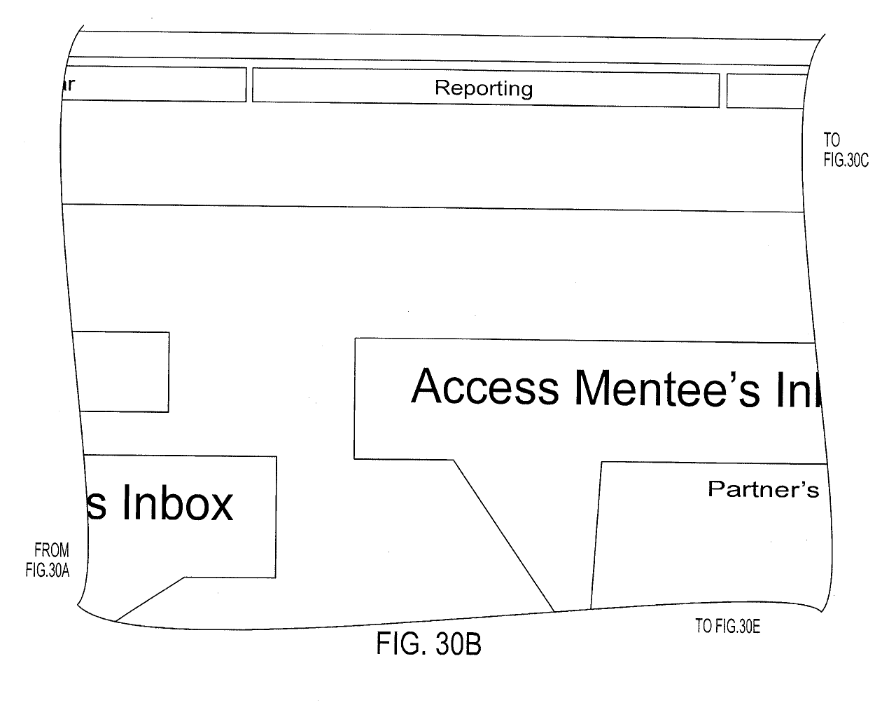

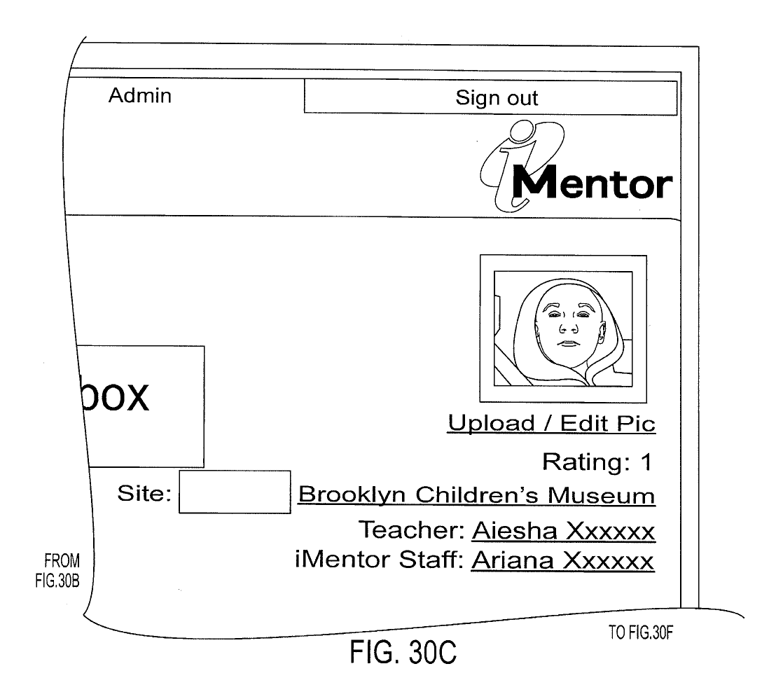

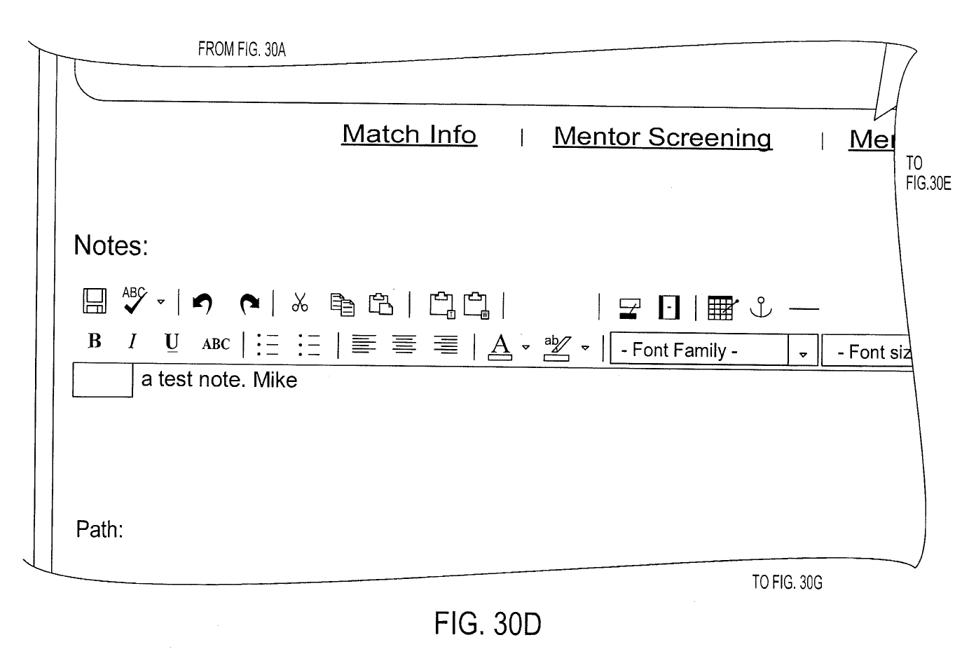

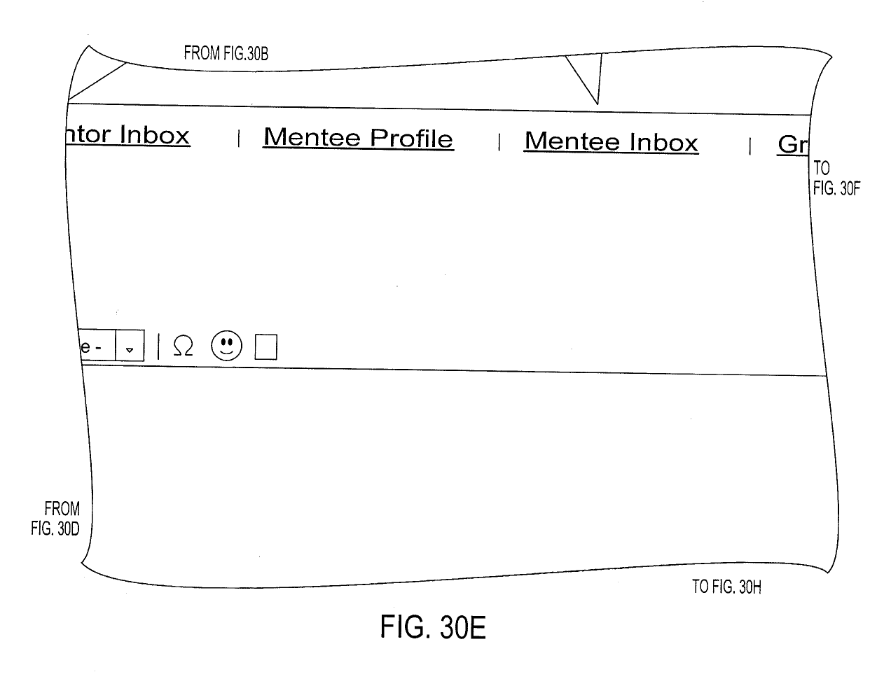

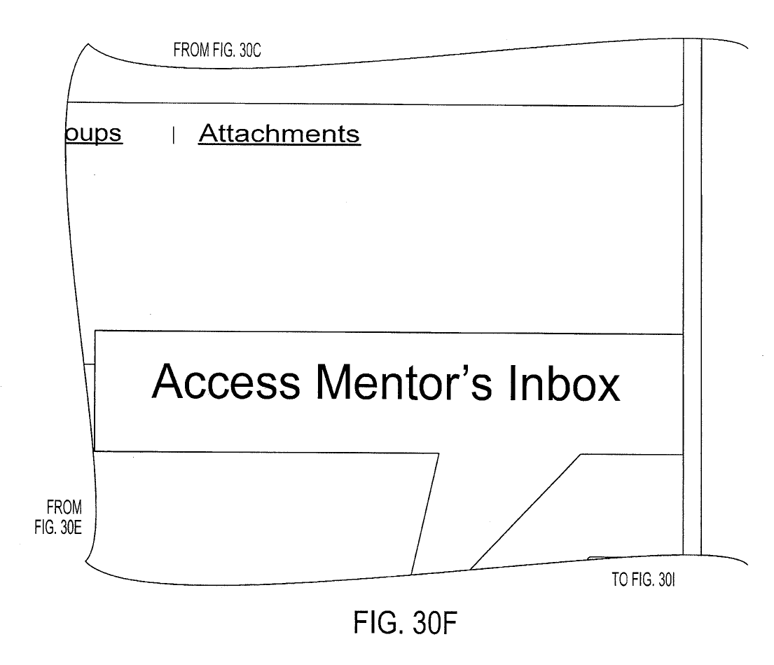

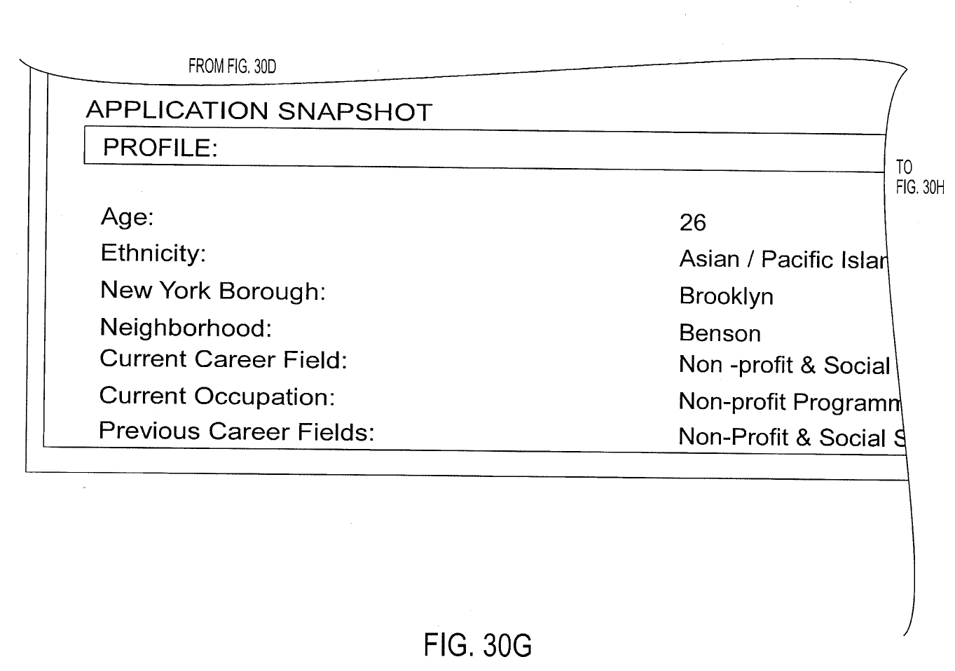

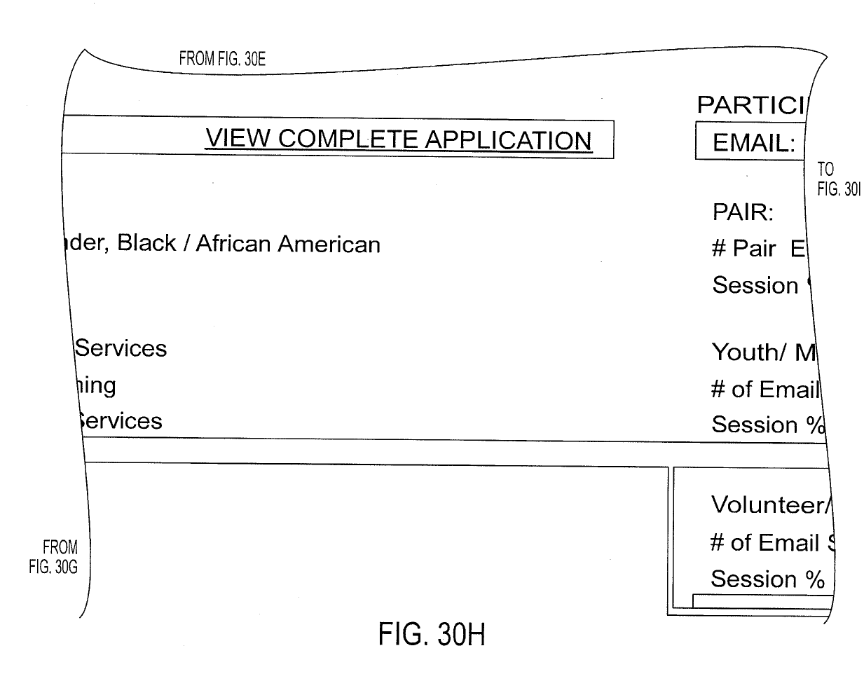

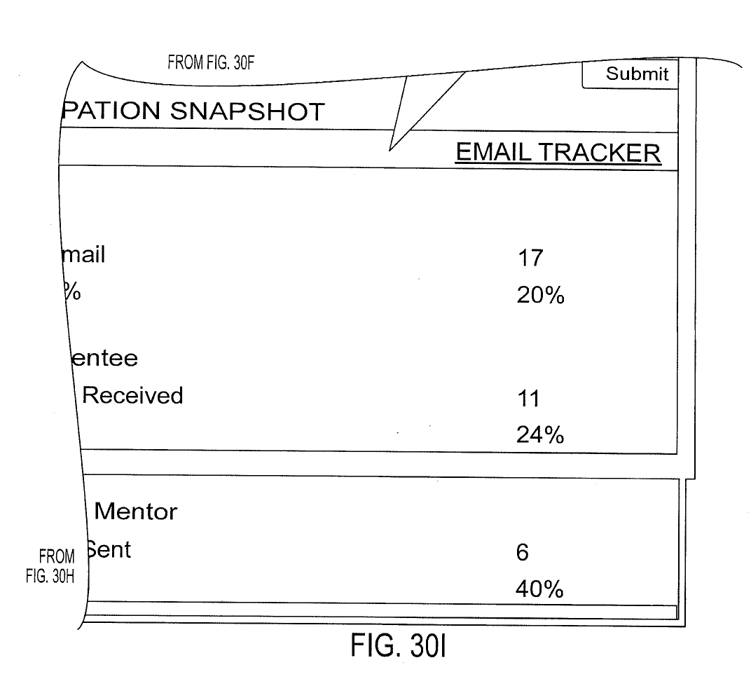

FIGS. 30A-30I illustrate an interface for tracking the activities of an individual mentor. As indicated by FIGS. 30A-30I, this interface provides access to the mentor's inbox, the mentee's inbox, the mentor's profile, and so on. The profile can be a resource for administrative users who are asked questions regarding e-mails or who desire to make general or specific notes about a user.

Another tool for conducting mentoring activities is a mentoring calendar. The mentoring calendar may be hosted by system 100 and it can be used by all different types of users. As with some other functions in system 100, what is available and viewable in the calendar may depend on (a) user access levels and (b) the contacts in the users' address book. For administrative users, the calendar may also be used for event management.

With the calendar, users can create events, track RSVPs, record attendance, as well as track and monitor all events created by mentor/mentee pairs. MA users may have access to two types of calendars: administrative calendars and personal calendars. An administrative calendar may allow MA users to view all appointments created for the member organization, including organization-sponsored events and appointments created by mentors and mentees. From the administrative calendar, a user can view all upcoming events, create events, invite attendees, track RSVPs, and record attendance. The administrative calendar may be accessed, for instance, through a graphical user interface. It may have several different views, such as a “month view,” “week view” or “day view.” These views show the events that are scheduled within the relevant time period.

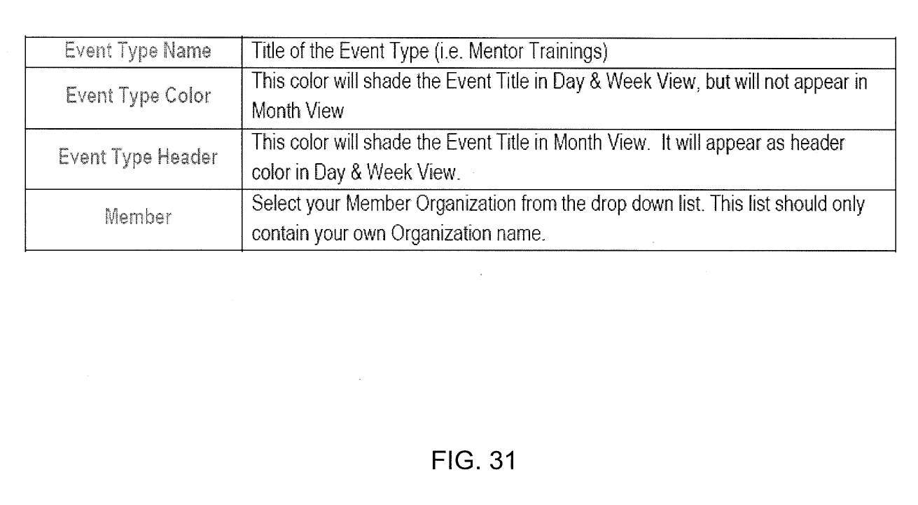

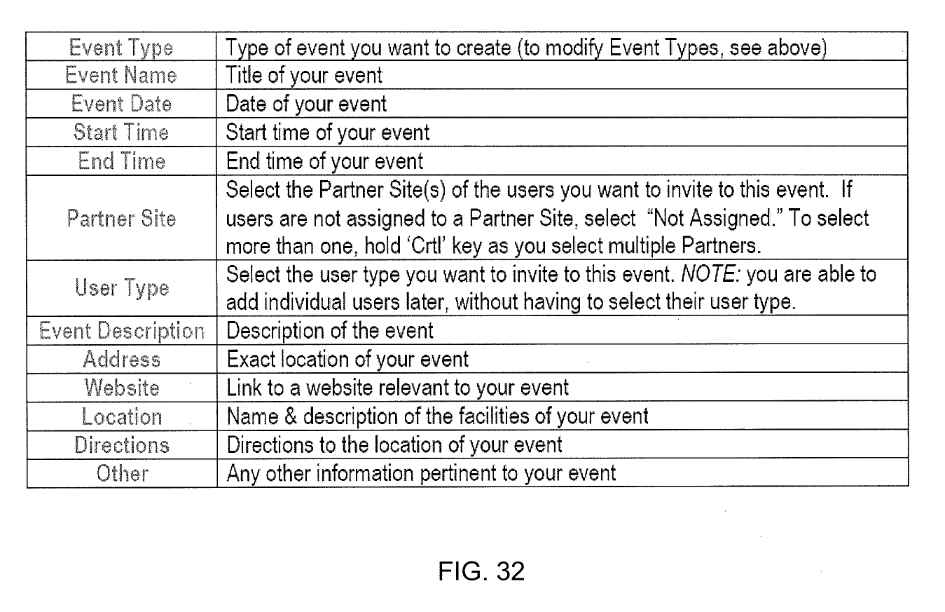

FIGS. 31 and 32 show information fields that may be used to create and monitor events. These fields can be entered into a calendar, and the corresponding information may be retrieved, for instance, by clicking on graphical elements of the calendar. In general, events may be organized by event type and creating color-coded labels for events on the calendar. MA users may be the only users allowed to create, edit and delete event types. A default event type may be an “appointment” representing a personal appointments.

MA users can create and manage events from an administrative calendar. An individual event may be created by submitting information corresponding to the fields shown in FIG. 32. After an event has been created and saved, invited attendees and invitees can be edited. When changes are made to events in a calendar, the invitees and attendees may be notified, e.g., through an automated notification procedure. Users can be invited to events by a number of electronic techniques, such as clicking user names from a list, or selecting groups of users based on user types or other criteria.

Members may send invitations to an event by first creating and saving an event and then choosing from the list of potential invitees, with an option to select all users. After selecting the invitees, users may then send an invitation email.

After inviting users to an event, additional invitees can be added at any time. Users may add invitees after sending an invitation through simple buttons on a graphic interface. First, the user may click the “admin” button, then click “event management,” and find the event in the month view. Users may click the event title to access the Edit Event Page, and then click View Attendees and then Add Attendees.

This action will bring the user to a new window listing all users not already invited to the event. Filters can allow the user to search for other users to be invited. The user may then select the checkbox for all users to be invited and click add. When the user clicks “close,” the event page can reload and include the added attendees.

These invitations may be tracked when users receive invitations to an event created by a member administrator. Users will receive a link to RSVP directly from the e-mail invitation. Users may indicate whether they will attend, will not attend, or do not know whether they will attend. Users can also have the option to add comments to the RSVP. The Member Administrator who created the event will receive an e-mail notification when a user has RSVP'd for the admin event, including the user's comments. Member administrators can also find RSVP comments in the admin calendar edit event page.

After a user has RSVP'd for an event, the appropriate RSVP icon can appear next to the user's name in the list of invited attendees. Users who have not yet RSVP'd to an event can be indicated by an “N/A” in the RSVP column. If a user added comments to the RSVP, those comments can appear in the comments column.

After an event has taken place, it can be helpful to record attendance. Users can log actual attendance in System 100. Recorded attendance can sync with the event tracker and mentor/mentee user profiles.

To record attendance, the user may click Admin, click Event Management, find the event in the Month View, click the event title to access the edit event page, and click Record Attendance. Under the RSVP Column is the RSVP responses from invited attendees. Users may select the appropriate Radio Button (Did Not Attend or Attended) for each user from the last two columns. Once finished, the user may click Update. The page will refresh and show the updated attendance count at the top of the page.

In addition to the admin calendar, member administrators also have access to a personal calendar. The personal calendar is where all events and personal appointments to which a user is invited can be listed. Each member administrator has a unique Personal Calendar. All users, including teachers, mentors, and mentees, will have access to their own System 100 personal calendar.

Users may access the personal calendar by clicking Calendar in the navigation bar. Users may view the personal calendar in the month view, week view, or day. The month view shows the first two events for each day. If there are more than two events in a day, a user may click More to view all events in day view. The week view shows seven days and all of the events for each day. Users may use the scroll bar to view events that are beyond the default hours of 6 a.m. to 8 p.m. The day view shows all events for a particular day. Users may use the scroll bar to view events that are beyond the default hours of 6 a.m. to 8 p.m.

Special icons may be used to indicate birthdays of the users in an address book. A special icon may appear on the days a user has sent or received e-mails. If more than one e-mail has been sent or received, the number of e-mails will appear next to the icon. All users may create and edit personal appointments and invite users who are in their address books.

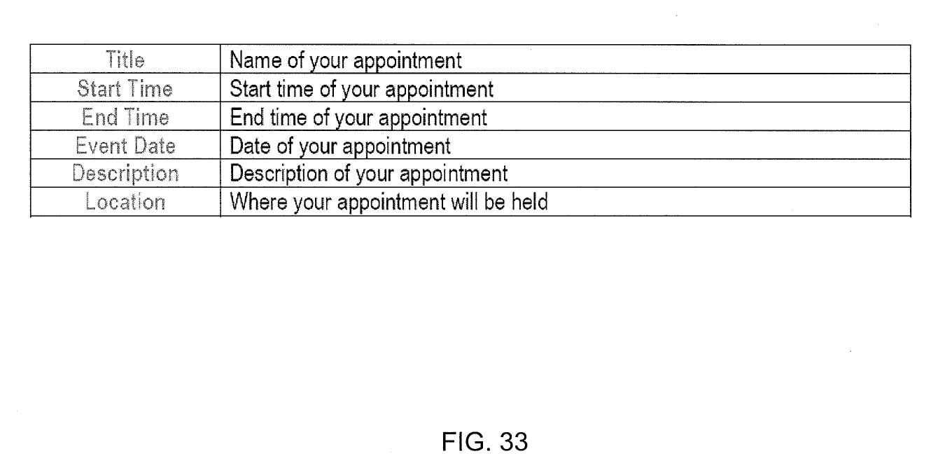

Personal appointments can appear on a calendar in default colors to distinguish them from organization-sponsored events. Personal appointments include information such as that indicated in the table of FIG. 33. After clicking the button on the graphical interface to create a personal appointment, users may enter the appointment details and save the entry. Similarly, users may edit an existing personal appointment by clicking Calendar and then clicking on the appointment title from the personal calendar in either month, week, or day view. When the appointment details appear in a new window, users may click Edit, modify the details as necessary, and save.

Once a personal appointment is made, users may invite any user from the address book to that personal appointment. This may be done by clicking calendar, then clicking the appointment title from the personal calendar, whether in month, week, or day view. After scrolling to the bottom of the appointment details page, a user may click Select Invitees, which will open the Invite Book with a list of users in the user's address book. The user may then select the checkbox next to the user(s) to be invited.

After selecting all invitees, the user may click Add to Invitation. The invitees will then be listed on the Appointment Details page, and the user may click Send Invite. Invitees will receive an automated e-mail to their System 100 accounts with the appointment details. They will also be prompted to RSVP to the appointment.

Users may be able to RSVP to personal appointment invitations in the same way that they will RSVP to administrator events. The creator of a personal appointment can receive e-mail notification when an invitee has RSVP'd. Personal Appointments may also be deleted or canceled by the appointment creator, which action can send a pre-written cancellation e-mail to all invitees.

System 100 allows back-end users to perform sophisticated analysis of all user information collected in pre- and post-evaluations. These analyses are conducted on user reports.

User reports may automatically synchronize with the online application and post-program evaluations to provide immediate access to responses from any question asked of front-end users. Back-end users can run reports on any combination of questions and answer choices, and system 100 may have the flexibility to run complex reports that assess the mentee and volunteer population, better target programs, improve fundraising reports and public relations materials. Such analyses may be performed by SA, NA, MA, and PA users. Such analyses may be based on user reports. For example, reports may be generated to determine active, ready-to-be-matched mentors who studied biology in college, the number of mentees who are in a certain age range, etc.

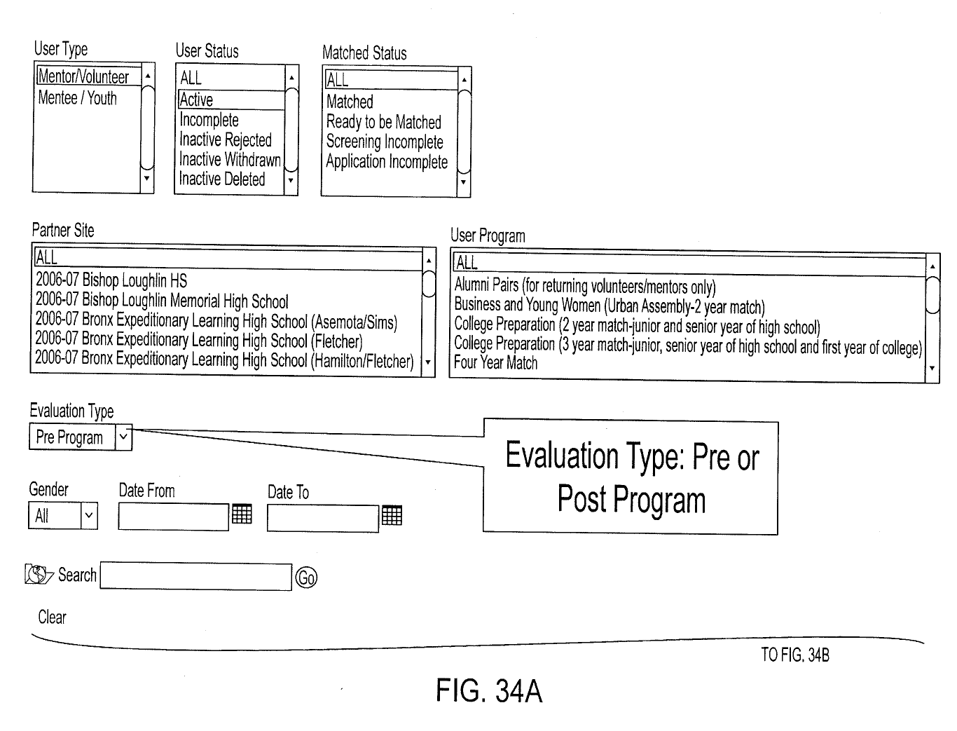

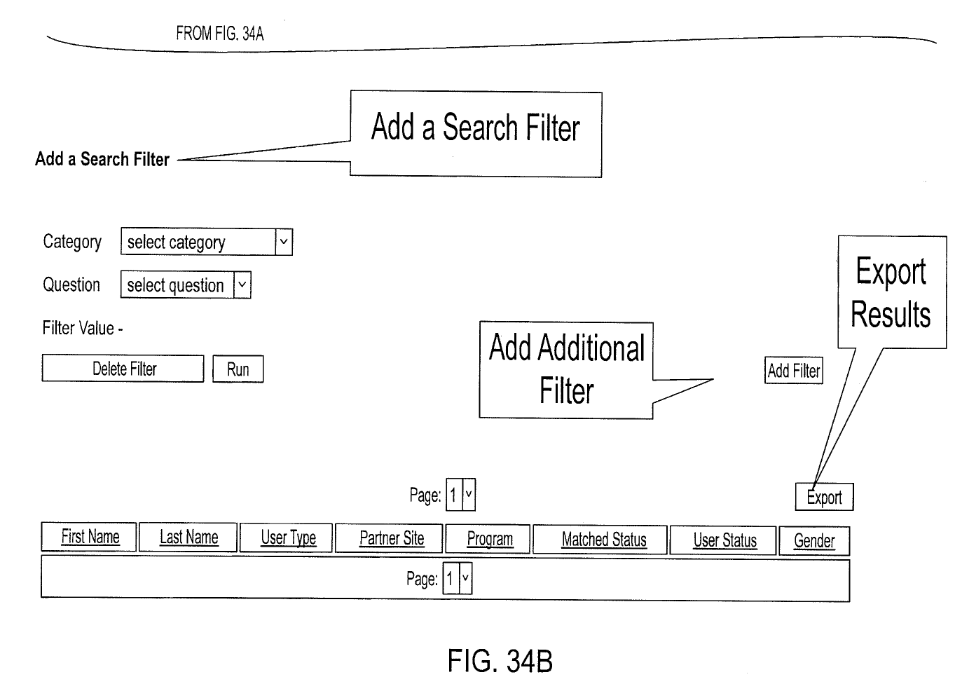

User reports can be accessed by clicking buttons through a graphical user interface such as that illustrated in FIGS. 34A-34B. To perform an analysis, the back-end user may use one or more filters to refine the information generated.

System 100 may also include customizable survey tools. A customizable survey tool will allow any member to create, deploy, and track surveys of its users. A survey can be deployed to any user type. The predominant types may include customizable entry, progress, and exit surveys and the results from surveys may drive much of the functionality system 100, including screening and matching. The survey system can allow administrators to create customizable surveys for mentor/mentee registration, mentor/mentee program progress, and mentor/mentee exit interview. At each of these stages, a survey can be conducted, for instance, to aid matching of mentors to mentees, to periodically assess the ongoing effectiveness of the mentor/mentee relationship, and to judge the ultimate effectiveness of the mentoring program.

Users who can create and manage surveys include back-end users, such as national administrators, member administrators, and partner site administrators. Relevant pages include survey management, survey detail, create a survey (integration with message management), edit/manage a survey, and survey tracker.

The survey management page is where an administrator user can generate a list of existing surveys. The page can allow for filtering results and results can include survey name, creation date, created by, deployed status, number invited to complete survey, number completed, number incomplete, number not started, and an editing function where questions can be viewed and edited.

The survey detail page enables an administrator user to view survey summary information, which may include survey name, parent survey if applicable, active date, number of invitees, and number of respondents. The page can also enable the administrator user to manage the surveys via three (3) core tabs; edit, invitees, and results. The edit tab can display the full survey, including name, creation date, deployment status, parent survey, question type, question, and answers. The survey may be editable inline.

Deployed surveys cannot be edited, though new questions can be added. The invitees tab can display all users who were invited to participate with key statistics, such as name, member type, member, partner, started/pending/complete, and view link. The view link will click through to the questions/answers for that respondent only. Clicking on the username will link to the user's profile. The results tab can display all questions (collapsed) with summary information. Expanding a question will show all respondents and their answer. The administrator user will also be able to view this question as a pre- or post-question pair by choosing another question via pop-up.

To create a survey the administrator user can click a link from the survey management page. A survey can be created from scratch, or an existing parent survey can be chosen as the template. To choose a parent survey, the administrator user can narrow the list of available parent surveys with filtering options and can click the survey name to use it as the parent. Whether starting with a parent survey or creating a new one from scratch, the user can define the survey name. If creating a new survey, the user can click the add question button, which will prompt the user to choose a question type. Once a question type is chosen, the user can click add answer to display a new field in which to enter the answer. The user may add as many question and answers as desired using this approach. The survey creation tool can provide standard WYSIWYG functions. Once a survey is complete, the user can click the save or deploy button. If saved, the survey will be saved to a master survey list in an undeployed state. If users choose the deploy button, they can be prompted for a deployment date (today or future) and then prompted to choose invitees using the full filtering feature (i.e., entire Member group, type of user within member group, partner group, or individuals). Finally users can be prompted to create a landing page, where they can choose yes or no. This message can be pre-populated via the template in message customization, and users can also have the ability to customize this message. Finally, users can be prompted to e-mail the survey. Once all required steps have been completed, the survey will be deployed or scheduled to be deployed.

The survey tracker page can include the filtering function and a list of all users who have completed surveys based on the filtering criteria. The user list can include all details that the invitee tab on the survey detail page includes, but it will also list all surveys that user has been invited to participate in and the status for each survey. An administrator user can click to send a message to any user on this list or click through to see their detailed answers to any survey in which they participated.

Within a survey, questions may be yes/no, multiple choice with multiple answers, multiple choice with one answer allowed, rating questions, short response, and long response. A survey may also use a date menu to allow users to select a date.

Back-end users, such as administrator users, may use a master participation report to filter the user list to specific groups of mentor/mentee pairs. A master participation report can display e-mail analysis, event analysis, and user list results. Such a report can include filter functions, action filters for e-mail trends or event trends, a dynamic chart of e-mail trends or event trends, and e-mail analysis. The e-mail analysis can include a table view of statistics for mentors, mentees, and combined mentor/mentee pairs. Such statistics can include events analysis, including the number of times a mentor/mentee pair has met. User results, can include the following information: partner site, mentee name, mentor name, match start date, match end date, total mentee e-mail count, total mentor e-mail count, total per e-mail count, mentee session percentage, perfect session percentage, mentee event attendance average, mentor event attendance average, pair meetings average, mentee obligation percentage, pair obligation percentage, and pair score.

Back-end users such as national administrators and member administrators may use screening tracker reports to produce reports on the status of a mentor/volunteer screening process. A number of filters can be available with this feature, including employment check, one reference complete, two references complete, three references complete, and background check.

The following fields can be included the results, edited inline, and dynamically saved. Additionally, columns may be sortable, e.g., by first name, last name, gender, date, employment check, reference checks, training complete, background check, user status, employer, e-mail address, and check box for available actions.

All user types within system 100 can have access to a homepage, which can be the first page the user sees when first logging on to system 100. Such a homepage can be dynamic based on user type, member group, and current persona. The homepage can welcome the user by username and display news and announcements. Such news and announcements can be managed by a back-end user and can be turned on or off during member setup. The information can include actions by back-end users in their network, including last login, e-mails to sent to username, e-mails received from username, invitations to events, RSVPs to events, shared “resource,” blog postings, changed user photos, updated contact information, if user was unmatched with username, if user was matched with username, status changes, and completed surveys. For front-end users, the information displayed can include e-mailed received from username, invitations to events, shared “resource,” blog postings by contacts, photo changes by contacts, updated contact information by contacts.

Updates on the homepage can include new e-mails, events, blogs posts, etc. The homepage may also display a user's network, including a thumbnail, username, and mail icon for the user's mentor, member administrator, partner administrator, and random user. The homepage can also include quick links, a user's saved resources, and quick polls. The homepage sections can be member-specific and defined during member setup by the super, member, or national administrator.

Another feature of system 100 that can be available to all users is the public profiles. These profiles can be viewable by everyone in the network affiliated with the appropriate partner site or member organization. The public profile can represent a user via a quick view. The public profile can be customized at the member level, and the member may choose to include public profiles or not. If members choose to include profiles, the following default sections can be displayed: name, picture, link to blog, link to e-mail user. Custom text fields, such as about me, career history, etc., may also be included in the profile. If the member chooses not to include profiles, the same information can be accessible via the user's address book instead of on the profile. When users view their own public profile, they may also see their matches, enabling a quick link to their matches' public profiles.

The user may be able to edit many of the sections in their profile, including picture, preferred phone number, all other contact and employer information, program preferences, partner site profile (public), and saved resources, etc.

When a user views his or her own public profile, that user (and only that user) may see an edit button next to each editable section. Clicking that button will enable the user to edit the section inline. Super, national, and member administrators may also see edit buttons on all profiles.

Backend profiles are meant for an access level above the user's access level to view and manage the user's information in the system 100. For this reason there can be two main types of backend profiles: user profiles and administrator profiles. The core difference is the amount of information available on each profile page. User profiles are profiles of mentors and mentees and have extensive information about the user as well as screening, match information, and application links. Administrator profiles are profiles of administrator users and will only have account information available for editing. The backend profiles can be available to any administrator user with access to administrator profiles and above the current user's level (i.e., partner, member, national, super). Backend profiles can also be available to mentor and mentee users.

A resource database can provide access to resource documents, videos, web-links, etc., uploaded into system 100, as well as links to outside resources to be used by any user on system 100. Members may upload their resources to be made available to their users. Information in the resource database may be available to users such as SA, NA, MA, PA, mentors, and mentees.

The resource main page is the landing page for the resource database and can display a search form, an advanced search link, a randomly (or member chosen) featured resource, the most popular resources, most popular member resources, and my saved resources. Clicking on a resource name will bring a user to a resource view page, which will display the title (linking to the resource detail), a short description, and the deadline (if available). Clicking on the resource title can either direct the user to the detail page, or expose hidden detail content on the same page. When displaying the resource view or detail page, action icons can enable the user to send to their network, save to “my resources”, or save as a calendar entry.

The resource search can be a simple keyword search, which can return results listed in order of relevance on the resource view page. Clicking on advanced search can display additional options, such as choose category, sub category, and deadline.

Another tool available to SA, NA, and MA levels is the resource management center. The resource management system can provide a space on system 100 for member organizations to host files on their customized platform and have access to them at any time, incorporating them into their use of system 100. An SA, NA, or MA can manage resources through a simple interface. When adding a resource, they can enter the following information: resource title, category, sub-category, deadline, description, tags, document type (Link, PDF, Word, etc.), and resource. If the user is a super administrator, when they view the resource manager they can see a few unique features.

First, they will have a delete button associated with resources. Second, they will see a list of member-added resources, which they can choose to edit and add to the global resource list to make it available to all members. Such edits by an SA should not change the original member's resource list.

The resources provided by system 100 may allow users to run successful online mentoring programs for different organizations. They may also include documentation of best practices, suggested documents to use, and quick links to the different parts of the platform with detailed directions for best results. Such documentation may be static HTML, but they can be edited via standard WYSIWYG editors.

User blogs within system 100 may allow users to keep track of their own mentoring development and share with others. There can be a front end and back end blog accessible through system 100. Blogs can include member blogs, user blogs and blog logs or reports. The back-end users may control blog permission settings and RSS feed permission settings.

When a member site is created and the blog option is chosen, the administrator user can have the option to create a member blog. If a member blog is created, there can be a multi-select box displaying all current administrator users for that member group. Administrators can then choose which administrators may edit the member blog. The member blog can include the same functionality as the user blogs outlined below. In addition, member blogs can be featured in the main navigation of the site, and the most recent post may be displayed on member users' homepages.

User blogs can also be available on System 100. When users enter their blog page for the first time, they can be prompted to create a name and enter tags for their blog. Once complete, an “add a blog” form may appear. This can be a simple form, that includes the blog post title, tags, image upload function, and preview and post functions.

When viewing the blog main page of another user, a thumbnail of the owner and a list of entries can be displayed. Each entry can include the username, date entered, post title, and first 300 characters of the post. Clicking on the post title can bring the user to the post detail page.

Once users have created their first post, the next time they click on their blog, they may see basically the same display that any other user would see when viewing the blog. The owner, however, may see link allowing the owner to edit previously posted blogs and a link to create a new post.

The blog detail page can display the username, date entered, post title, as well as the formatted, full post, including images. In addition, any user in the blog owners network may be able post a comment to a blog entry.

All blog entries posted on the site can be automatically logged in a blog log within system 100, allowing an administrator to monitor and screen all communication on the platform. The blog log can serve as a quality control and communications-monitoring tool for member staff. An administrator user can also use the blog log to run reports on blog posts by a given date range, partner site, or user type.

When running a report, an administrator may export the report to a spreadsheet, clear the report and run a new report, use an auto-count feature to count results, sub-sort the report, access a user's profile, and create e-mail alerts for keywords from the blog log.

Another feature of system 100 is content management. A content management tool can allow administrator users to navigate the site and find all content that can be edited by a member, including curriculum, resources, news, and announcements.

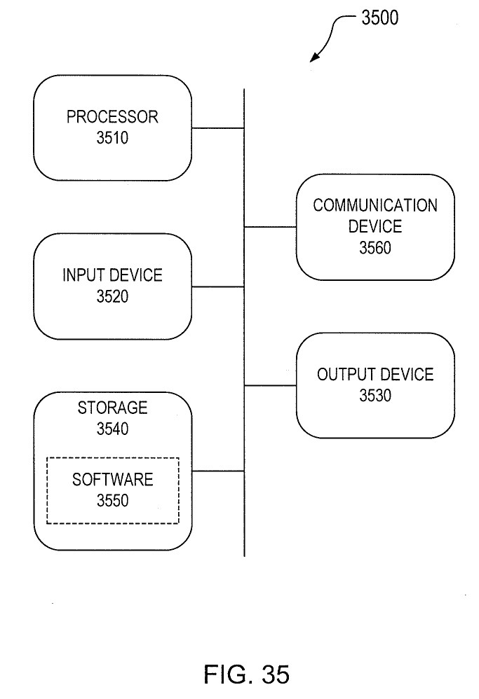

FIG. 35 shows a block diagram of an example of a computing device, which may generally correspond to a client or a server for implementing the invention described herein. The form of computing device 3500 may be widely varied. For example, computing device 3500 can be a personal computer, workstation, server, handheld computing device, or any other suitable type of microprocessor-based device. Computing device 3500 can include, for example, one or more components including processor 3510, input device 3520, output device 3530, storage 3540, and communication device 3560. These components may be widely varied, and can be connected to each other in any suitable manner, such as via a physical bus, network line or wirelessly for example.

For example, input device 3520 may include a keyboard, mouse, touch screen or monitor, voice-recognition device, or any other suitable device that provides input. Output device 3530 may include, for example, a monitor or other display, printer, disk drive, speakers, or any other suitable device that provides output.

Storage 3540 may include volatile and/or nonvolatile data storage, such as one or more electrical, magnetic or optical memories such as a RAM, cache, hard drive, CD-ROM drive, tape drive or removable storage disk for example. Communication device 3560 may include, for example, a network interface card, modem or any other suitable device capable of transmitting and receiving signals over a network.

The interconnecting network may include any suitable interconnected communication system, such as a local area network (LAN) or wide area network (WAN) for example. Network 105 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 3550 can be stored in storage 3540 and executed by processor 3510, and may include, for example, programming that embodies the functionality described in the various embodiments of the present disclosure. The programming may take any suitable form.

Software 3550 can also be stored and/or transported within any computer-readable storage medium for use by or in connection with an instruction execution system, apparatus, or device, such as computing device 3500 for example, that can fetch instructions associated with the software from the instruction execution system, apparatus, or device and execute the instructions. In the context of this document, a computer-readable storage medium can be any medium, such as storage 3540 for example, that can contain or store programming for use by or in connection with an instruction execution system, apparatus, or device.

Software 3550 can also be propagated within any transport medium for use by or in connection with an instruction execution system, apparatus, or device, such as computing device 3500 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed:

1. A method for facilitating interactions between a mentor and a mentee within a computational platform, comprising:
storing a mentor profile and a mentee profile within the computational platform;
storing a plurality of writing prompts within the computational platform, each of the writing prompts containing information regarding a suggested topic to be addressed in a communication between a mentor and a mentee;
displaying one of the writing prompts to the mentor or mentee; and
receiving an e-mail message from the mentor or mentee based on the displayed writing prompt.

2. The method of claim 1, further comprising:
granting access for an administrative user to view monitoring information regarding communications between the mentor and the mentee, the monitoring information indicating a frequency of e-mail communications between the mentor and mentee.

3. The method of claim 1, further comprising:
storing a calendar of events for the mentor and mentee, the events indicating scheduled interactions between the mentor and mentee; and
granting access to the calendar to the mentor and mentee, and at least one administrative user.

4. The method of claim 1, wherein the mentor is a college graduate and the mentee is a high school student.

5. The method of claim 1, further comprising:
storing a mentoring curriculum for the mentor and the mentee, the mentoring curriculum including an ordered sequence of the writing prompts and one or more proposed in-person visits between the mentor and mentee.

6. The method of claim 5, further comprising:
presenting the mentoring curriculum to the mentor in a plurality of electronic messages.

7. The method of claim 1, wherein the mentor profile includes mentor background information and the mentee profile includes mentee background information and the computational platform further stores strength of match data for the mentor and mentee, the strength of match data indicating a level of compatibility between the mentor and mentee based on mentor background information and the mentee background information.

8. The method of claim 1, wherein the e-mail message is transmitted via a closed e-mail network wherein users may only receive e-mail messages from e-mail addresses on record within the computational platform.

9. A method for establishing a mentoring relationship between a mentor and a mentee using a computational platform, comprising:
storing profile information for a plurality of prospective mentors within the computational platform;
storing profile information for a plurality of prospective mentees within the computational platform;
comparing the profile information of the plurality of mentors with the profile information of the plurality of mentees to generate a plurality of match scores indicating a degree of similarity between the profile information of each of the plurality of mentors and the profile information of each of the prospective mentees.

10. The method of claim 9, further comprising:
displaying a list of potential matches for one of the prospective mentors or mentees, wherein the potential matches are displayed based on relative values of the match scores.

11. The method of claim 10, further comprising:
receiving a selection of one of the displayed potential matches and creating a match within the computational system between one of the prospective mentors and one of the prospective mentees based on the selection.

12. The method of claim 11, further comprising:
after the match is created, sending a match message to announce the match to the prospective mentor and the prospective mentee who are parties to the match, wherein the match message indicates the occurrence of the match and provides information to each of the parties regarding the identity of the other party.

13. A system for facilitating interactions between a mentor and a mentee, comprising:
a data storage component storing a mentor profile, a mentee profile, and a plurality of writing prompts, each of the writing prompts containing information regarding a suggested topic to be addressed in a communication between a mentor and a mentee;
a curriculum management module configured to send the writing prompts to the mentor or mentee; and
an e-mail server configured to receive e-mail messages from the mentor or mentee, wherein the e-mail messages include information composed based on the writing prompts.

14. The system of claim 13, further comprising:
an access management component granting access for an administrative user to view monitoring information regarding communications between the mentor and the mentee, the monitoring information indicating a frequency of e-mail communications between the mentor and mentee.

15. The system of claim 13, wherein the data storage component further stores a calendar of events for the mentor and mentee, the events indicating scheduled interactions between the mentor and mentee; and
wherein the access management component grants access to the calendar to the mentor and mentee, and at least one administrative user.

16. The system of claim 13, wherein the mentor is a college graduate and the mentee is a high school student.

17. The system of claim 13, wherein the data storage component further stores a mentoring curriculum for the mentor and the mentee, the mentoring curriculum including an ordered sequence of the writing prompts and one or more proposed in-person visits between the mentor and mentee.

18. The system of claim 13, wherein the mentor profile includes mentor background information and the mentee profile includes mentee background information and the data storage component further stores strength of match data for the mentor and mentee, the strength of match data indicating a level of compatibility between the mentor and mentee based on mentor background information and the mentee background information.

19. The system of claim 13, wherein the e-mail messages are transmitted via a closed e-mail network wherein users may only receive e-mail messages from e-mail addresses on record within the closed network.

20. The system of claim 13, further comprising:
a screening interface allowing administrative users to view information regarding prospective mentors and to enter information determining whether the prospective mentors qualify to participate in mentoring activities.
